(19) United States
(12) Patent Application Publication
(10) Pub. No.: US 2024/0421484 A1
(43) Pub. Date: Dec. 19, 2024

(54) ELECTRONIC DEVICE INCLUDING ANTENNA

(71) Applicant: SAMSUNG ELECTRONICS CO., LTD., Suwon-si (KR)

(72) Inventor: Seongjun SONG, Suwon-si (KR)

(21) Appl. No.: 18/621,296

(22) Filed: Mar. 29, 2024

Related U.S. Application Data
(63) Continuation of application No. PCT/KR2024/003238, filed on Mar. 13, 2024.

(30) Foreign Application Priority Data
Jun. 16, 2023 (KR) 10-2023-0077751
Aug. 29, 2023 (KR) 10-2023-0114041

(51) Int. Cl. H01Q 5/50; H01Q 1/24; H01Q 1/42; H01Q 3/24

(52) U.S. Cl. CPC H01Q 5/50; H01Q 1/241; H01Q 1/42; H01Q 3/24

(57) ABSTRACT

An electronic device includes a housing including a first housing part and a second housing part, a first substrate disposed on the second housing part, a second substrate disposed on the first housing part, a third substrate electrically connecting the first substrate and the second substrate, at least one processor disposed on the first substrate, an RF transceiver disposed on the first substrate, a first coupler disposed on the first substrate and configured to provide a first coupling signal based on a first signal, and a second coupler disposed on the second substrate and configured to provide a second coupling signal based on a second signal.

### CROSS-REFERENCE TO RELATED APPLICATIONS

This application is a continuation of International Application No. PCT/KR2024/003238 designating the United States, filed on Mar. 13, 2024, in the Korean Intellectual Property Receiving Office and claiming priority to Korean Patent Application Nos. 10-2023-0077751, filed on Jun. 16, 2023, and 10-2023-0114041, filed on Aug. 29, 2023, in the Korean Intellectual Property Office, the disclosures of each of which are incorporated by reference herein in their entireties.

### BACKGROUND

### Field

The descriptions below relate to an electronic device including an antenna.

### Description of Related Art

An electronic device including a large-screen display may increase user utilization. As demand for a highly portable electronic device increases, the electronic device may include a deformable display. The deformable display may be slidably deformable. The electronic device may include housing parts that are movably coupled to each other for the deformable display. Each of the housing parts may include substrates (e.g., a printed circuit board) electrically connected to an electronic component. The substrates may be spaced apart from each other.

The above-described information may be provided as a related art for the purpose of helping understand the present disclosure. No claim or determination is raised as to whether any of the above-described information may be applied as a prior art related to the present disclosure.

### SUMMARY

An electronic device is provided. The electronic device may comprise a housing, a memory, a first substrate, a second substrate, a third substrate, at least one processor, an RF transceiver, a first coupler, and a second coupler. The housing may include a first housing part and a second housing part movably coupled to each other. The memory may store instructions. The first substrate may be disposed on the second housing part. The second substrate may be disposed on the first housing part. The third substrate may be deformable based on a movement of the first housing part or the second housing part. The third substrate may electrically connect the first substrate and the second substrate. The at least one processor may be disposed on the first substrate. The radio frequency (RF) transceiver may be disposed on the first substrate. The first coupler may be disposed on the first substrate. The first coupler may be configured to provide a first coupling signal based on a first signal from the RF transceiver. The second coupler may be disposed on the second substrate. The second coupler may be configured to provide a second coupling signal based on a second signal from the third substrate.

An electronic device is provided. The electronic device may comprise a memory, a first substrate, a second substrate, a third substrate, at least one processor, an RF transceiver, a first coupler, a second coupler, and an antenna. The memory may store instructions. The second substrate may be space apart from the first substrate. The third substrate may electrically connect the first substrate and the second substrate. The third substrate may include a first connector connected to the first substrate and a second connector connected to the second substrate. The at least one processor may be disposed on the first substrate. The RF transceiver may be disposed on the first substrate. The first coupler may be disposed on the first substrate. The first coupler may be configured to provide a first coupling signal based on the first signal from the RF transceiver. The second coupler may be disposed on the second substrate. The second coupler may be configured to provide a second coupling signal based on the second signal from the third substrate. The antenna may be electrically connected to the second coupler through the second substrate. The at least one processor may be configured to identify a difference between an electrical characteristic of the first coupling signal provided from the first coupler and an electrical characteristic of the second coupling signal provided from the second coupler. The at least one processor may be configured to change a transmission power outputted through the RF transceiver, based on identifying that the difference between the electrical characteristic of the first coupling signal and the electrical characteristic of the second coupling signal exceeds a reference value.

### BRIEF DESCRIPTION OF THE DRAWINGS

FIG. 1 is a block diagram of an electronic device in a network environment according to an embodiment.

FIG. 2A is a top plan view of an exemplary electronic device in a first state.

FIG. 2B is a bottom view of an exemplary electronic device in a first state.

FIG. 2C is a top plan view of an exemplary electronic device in a second state.

FIG. 2D is a bottom view of an exemplary electronic device in a second state.

FIGS. 3A and 3B are exploded perspective views of an exemplary electronic device.

FIG. 4A is a cross-sectional view of an exemplary electronic device in a first state.

FIG. 4B is a cross-sectional view of an exemplary electronic device in a second state.

FIG. 5A illustrates the inside of an exemplary electronic device in a first state.

FIG. 5B illustrates the inside of an exemplary electronic device in a second state.

FIG. 5C is an exploded perspective view of an exemplary electronic device.

FIG. 6A illustrates a first substrate, a second substrate, and a third substrate, in a first state.

FIG. 6B illustrates a first substrate, a second substrate, and a third substrate, in a second state.

FIG. 7A is a graph illustrating a reflection coefficient of an RF signal according to an

angle of a portion of a third substrate.

FIG. 7B is a graph illustrating a transmission coefficient of an RF signal according to an angle of a portion of a third substrate.

FIG. 8A is a schematic block diagram of an exemplary electronic device.

FIG. 8B illustrates an exemplary single directional coupler.

FIG. 8C illustrates an exemplary first substrate.

FIG. 8D illustrates an exemplary second substrate.

FIG. 9 is a flow chart indicating an operation of an exemplary electronic device.

FIG. 10 is a flow chart indicating an example of an operation of changing transmission power based on power.

FIG. 11 is a flow chart indicating an example of an operation of changing an operating frequency of an antenna based on an SNR.

FIG. 12 is a flow chart indicating an example of an operation of changing an antenna based on an SNR.

FIG. 13A is a schematic block diagram of an exemplary electronic device.

FIG. 13B illustrates an exemplary dual directional coupler.

FIG. 13C illustrates an exemplary third substrate.

FIG. 13D is a cross-sectional view of an exemplary third substrate cut along C-C′ of FIG. 13C.

FIG. 14A is a flow chart indicating an example of an operation of changing an impedance of a transmission signal based on a VSWR.

FIG. 14B illustrates an exemplary antenna switching circuit.

### DETAILED DESCRIPTION

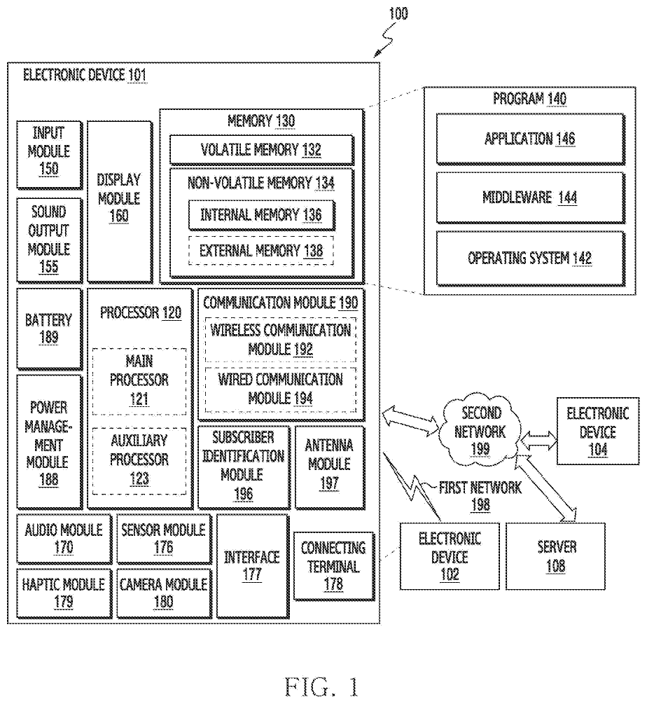

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating clement composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

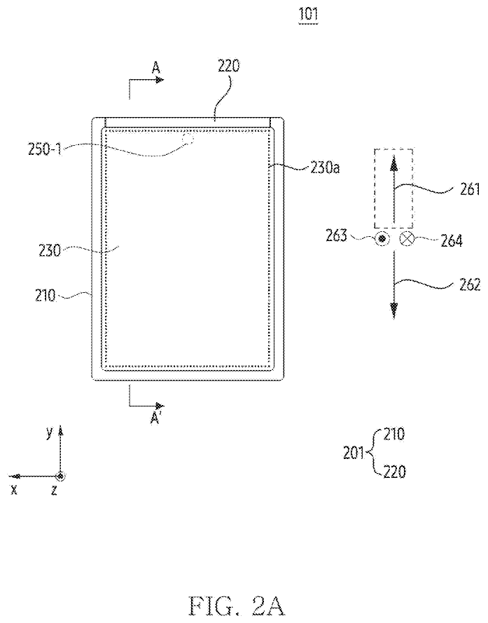

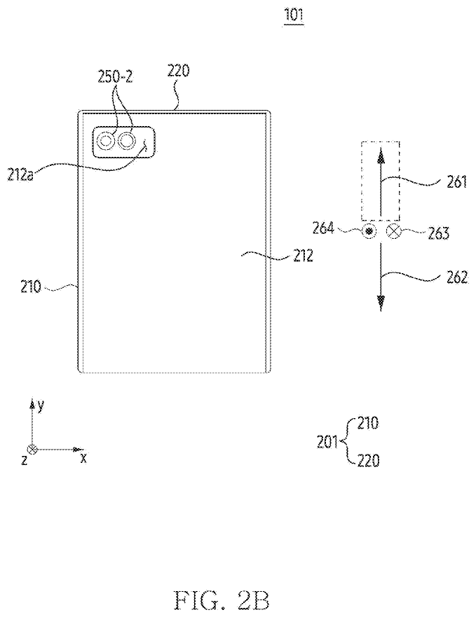

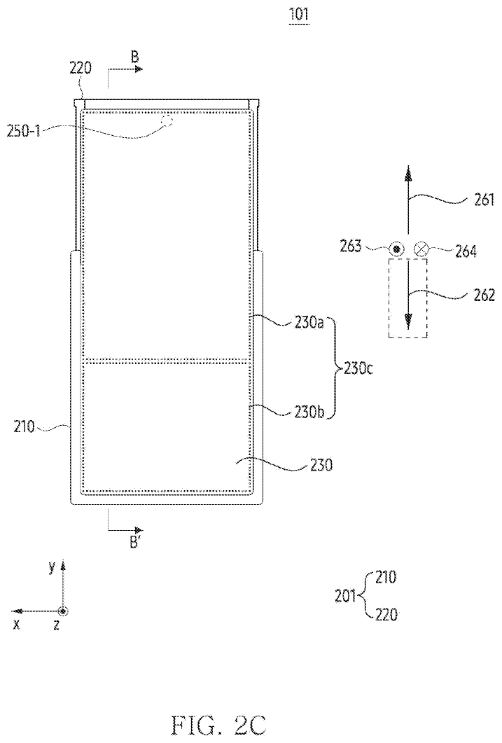

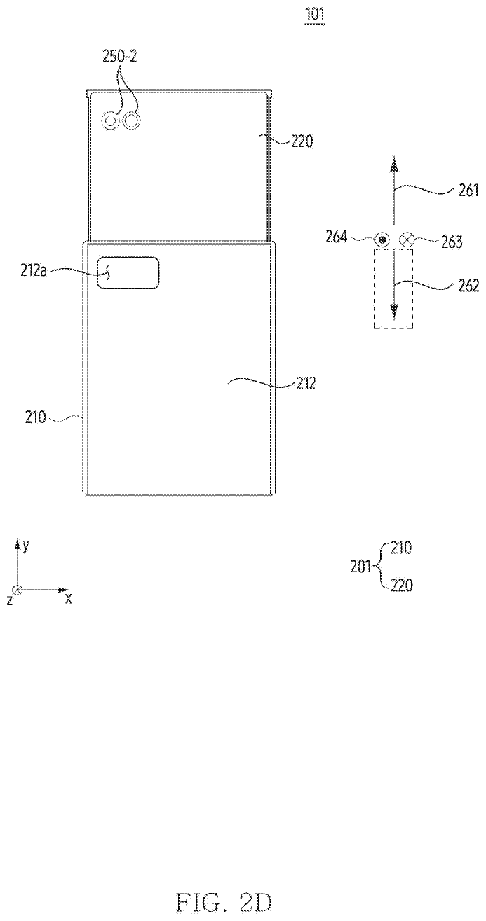

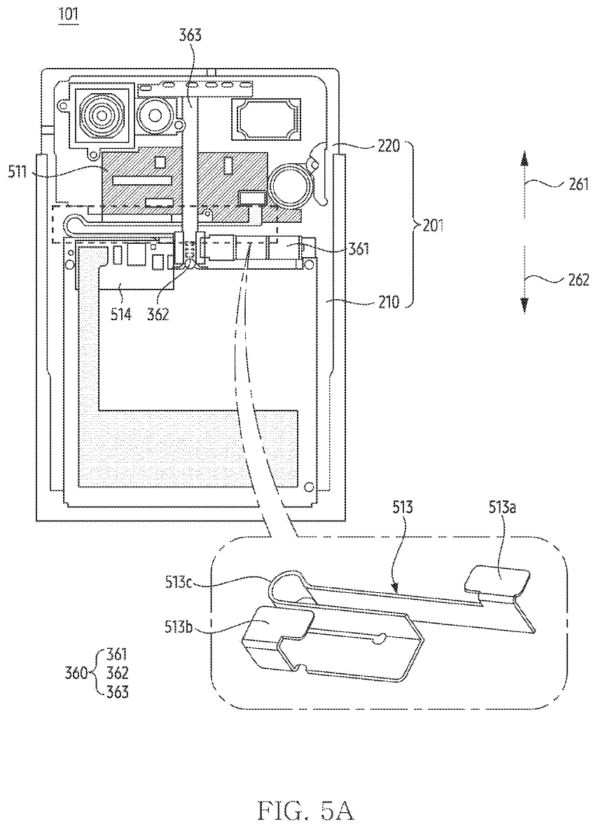

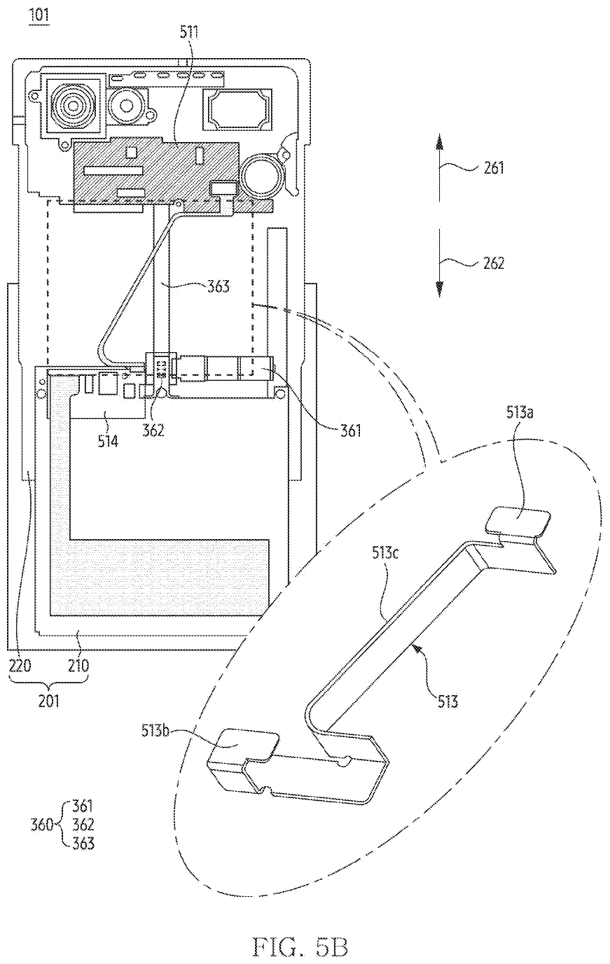

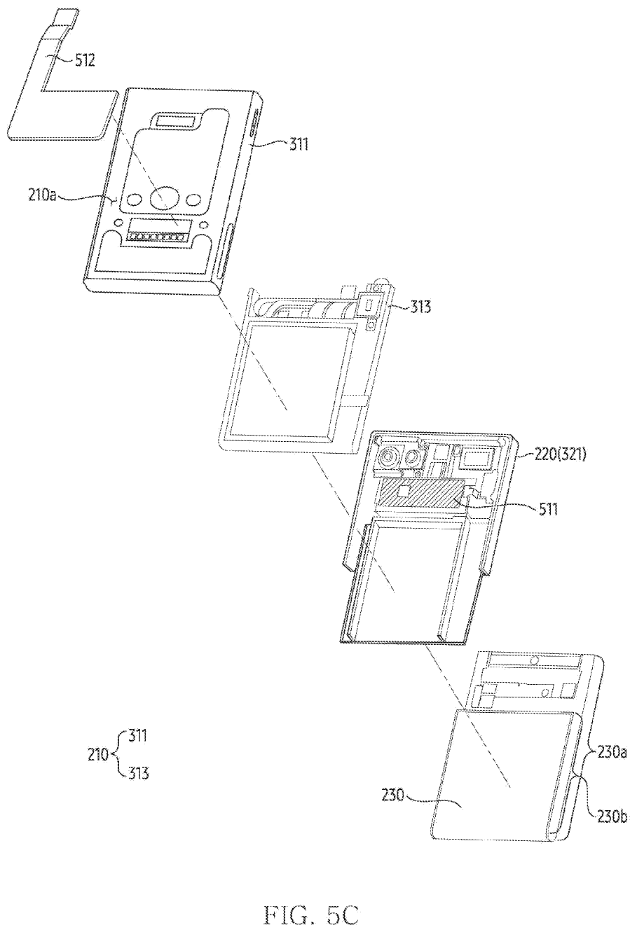

For example, a display of the display module 160 may be flexible. For example, the display may include a display area exposed outside a housing (e.g., a housing 201 of FIG. 5A) of the electronic device 101 that provides at least a portion of an outer surface of the electronic device 101. For example, since the display has flexibility, at least a portion of the display may be rollable into the housing or slidable into the housing. For example, a size of the display area may be changed depending to a size of the at least a portion of the display rolled into the housing or slid into the housing. For example, the electronic device 101 including the display may be in a plurality of states including a first state providing the display area having a first size and a second state providing the display area having a second size different from the first size. For example, the first state may be exemplified through a description of FIGS. 2A and 2B.

FIG. 2A is a top plan view of an exemplary electronic device in a first state.

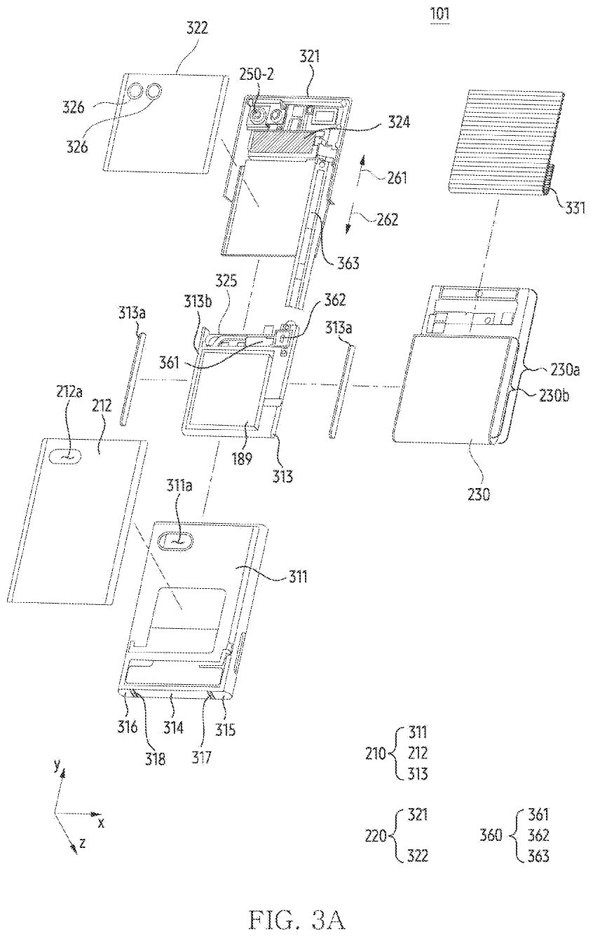

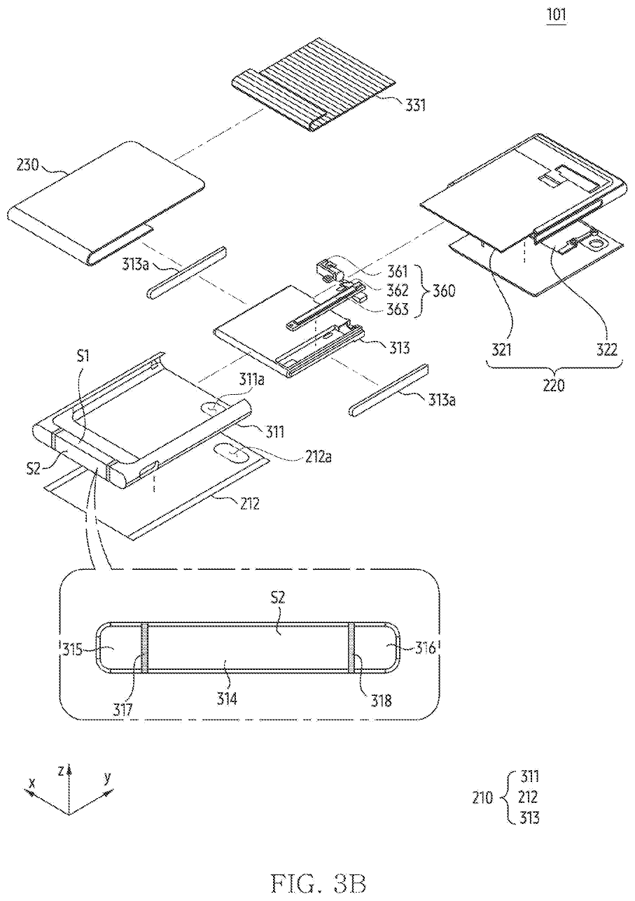

Referring to FIG. 2A, an electronic device 101 may include a housing 201 and a display 230 (e.g., the display). For example, the housing 201 may include a first housing part 210 and a second housing part 220, which is movable with respect to the first housing part 210 in a first direction 261 parallel to a y axis or in a second direction 262 parallel to the y axis and opposite to the first direction 261. Alternatively, the first and second housing parts 210 and 220 can be movable relative to each other in the first direction 261 or in the second direction 262. Although the second housing part 220 is described to be moved with respect to the first housing part 210 in the present disclosure, the present disclosure is not limited thereto. For example, the housing 201 may have a structure in which an overall size of the housing 201 may be changed according to a change in a relative positional relationship between the first housing part 210 and the second housing part 220. For example, the relative positional relationship between the first housing part 210 and the second housing part 220 may be changed by an operation of a motor (e.g., a motor 361 of FIG. 3A), which will be described later. For example, by the motor 361, the first housing part 210 or the second housing part 220 may be movable, or both the first housing part 210 and the second housing part 220 may be movable.

For example, the electronic device 101 may be in the first state. For example, in the first state, the second housing part 220 may be movable with respect to the first housing part 210 in the first direction 261 among the first direction 261 and the second direction 262. For example, in the first state, the second housing part 220 may not be movable in the second direction 262 with respect to the first housing part 210.

For example, in the first state, the display 230 may provide the display area having the smallest size. For example, in the first state, the display area may correspond to an area 230a. For example, although not illustrated in FIG. 2A, in the first state, an area (e.g., an area 230b of FIG. 2C) of the display 230 different from the area 230a, which is the display area, may be included in the first housing part 210. For example, in the first state, the area (e.g., the area 230b of FIG. 2C) may be covered by the first housing part 210. For example, in the first state, the area may be rollable into the first housing part 210. For example, in the first state, the area 230a may include a planar portion. However, it is not limited to thereto. For example, in the first state, the area 230a may include a curved portion extending from the planar portion and located in an edge portion.

For example, the first state may be referred to as a slide-in state or a closed state in terms of at least a portion of the second housing part 220 being located in the first housing part 210. For example, the first state may be referred to as a contracted state in terms of providing the display area having the smallest size. However, it is not limited thereto.

For example, the second housing part 220 may include a first image sensor 250-1 in the camera module 180 exposed through a portion of the area 230a and facing a third direction 263 parallel to a z-axis. For example, although not illustrated in FIG. 2A, the second housing part 220 may include one or more second image sensors in the camera module 180 exposed through a portion of the second housing part 220 and facing a fourth direction 264 parallel to the z-axis and opposite to the third direction 263. For example, the one or more second image sensors may be exemplified through a description of FIG. 2B.

FIG. 2B is a bottom view of an exemplary electronic device in a first state.

Referring to FIG. 2B, in the first state, one or more second image sensors 250-2 disposed in a second housing part 220 may be located within a structure disposed in a first housing part 210 for the one or more second image sensors 250-2. For example, in the first state, light from outside of an electronic device 101 may be received by the one or more second image sensors 250-2 through the structure. For example, since the one or more second image sensors 250-2 are located within the structure in the first state, the one or more second image sensors 250-2 may be exposed through the structure in the first state. For example, the structure may be implemented in various ways. For example, the structure may be an opening or a notch. For example, the structure may be an opening 212a in a first plate 212 of the first housing part 210 surrounding at least a portion of the second housing part 220. However, it is not limited thereto. For example, in the first state, the one or more second image sensors 250-2 included in the second housing part 220 may be covered by the first plate 212 of the first housing part 210.

For example, the first state may be changed to the second state.

For example, the first state (or the second state) may be changed to the second state (or the first state) through intermediate states between the first state and the second state.

For example, the first state (or the second state) may be changed to the second state (or the first state) based on a user input. For example, the first state (or the second state) may be changed to the second state (or the first state) in response to a user input to a physical button exposed through a portion of the first housing part 210 or a portion of the second housing part 220. For example, the first state (or the second state) may be changed to the second state (or the first state) in response to a touch input for an executable object displayed in the display area. For example, the first state (or the second state) may be changed to the second state (or the first state) in response to a touch input having a contact point on the display area and having a pressing strength greater than or equal to a reference strength. For example, the first state (or the second state) may be changed to the second state (or the first state) in response to a voice input received through a microphone of the electronic device 101. For example, the first state (or the second state) may be changed to the second state (or the first state) in response to an external force applied to the first housing part 210 and/or the second housing part 220 to move the second housing part 220 with respect to the first housing part 210. For example, the first state (or the second state) may be changed to the second state (or the first state) in response to a user input identified in an external electronic device (e.g., earbuds or smart watch) connected to the electronic device 101. However, it is not limited thereto.

The second state may be exemplified through a description of FIGS. 2C and 2D.

FIG. 2C is a top plan view of an exemplary electronic device in a second state.

Referring to FIG. 2C, an electronic device 101 may be in the second state. For example, in the second state, a second housing part 220 may be movable with respect to a first housing part 210 in a second direction 262 among a first direction 261 and the second direction 262. For example, in the second state, the second housing part 220 may not be movable in the first direction 261 with respect to the first housing part 210.

For example, in the second state, a display 230 may provide the display area having the largest size. For example, in the second state, the display area may correspond to an area 230c including an area 230a and an area 230b. For example, the area 230b that was included in the first housing part 210 in the first state may be exposed in the second state. For example, in the second state, the area 230a may include a planar portion. However, it is not limited thereto. For example, the area 230a may include a curved portion extending from the planar portion and located in an edge portion. For example, in the second state, the area 230b may include the planar portion among the planar portion and the curved portion, unlike the area 230a in the first state. However, it is not limited thereto. For example, the area 230b may include the curved portion extending from the planar portion of the area 230b and located in the edge portion.

For example, the second state may be referred to as a slide-out state or an open state in terms of at least a portion of the second housing part 220 disposed outside the first housing part 210 extending with respect to the first state. For example, the second state may be referred to as an expanded state in terms of providing the display area having the largest size. However, it is not limited thereto.

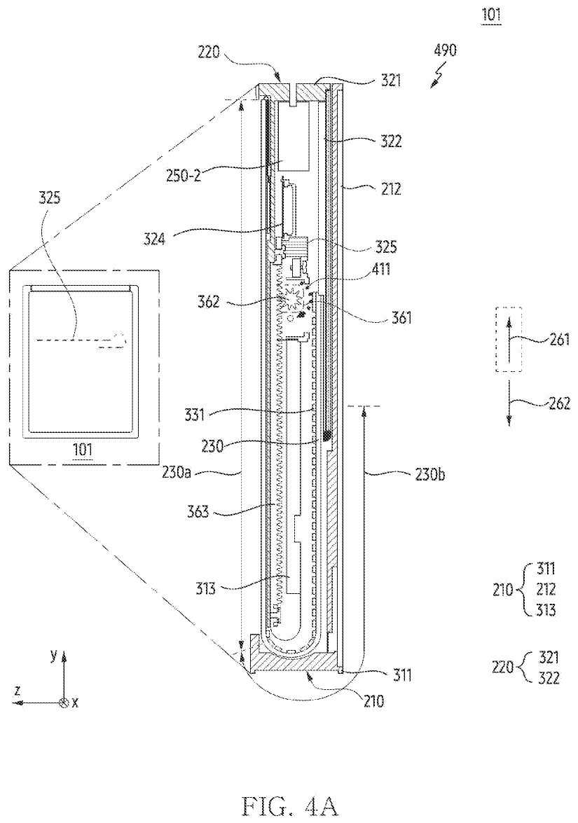

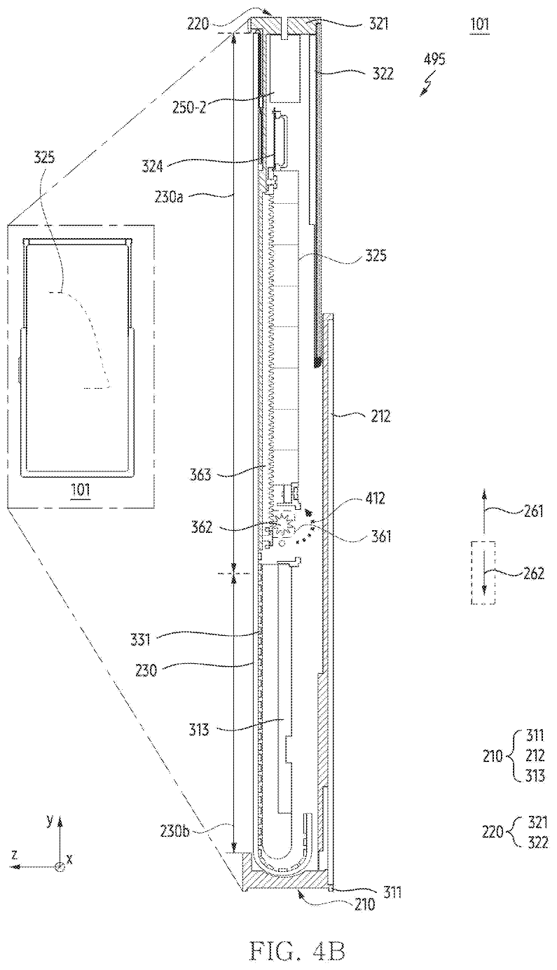

For example, when a state of the electronic device 101 changes from the first state to the second state, a first image sensor 250-1 facing a third direction 263 may be moved together with the area 230a according to movement of the second housing part 220 in the first direction 261. For example, although not illustrated in FIG. 2C, one or more second image sensors 250-2 facing a fourth direction 264 may be moved according to the movement of the second housing part 220 in the first direction 261 when the state of the electronic device 101 is changed from the first state to the second state. For example, a relative positional relationship between the one or more second image sensors 250-2 and the structure exemplified through a description of FIG. 4B may be changed according to the movement of the one or more second image sensors 250-2. For example, the change in the relative positional relationship may be exemplified through FIG. 2D.

FIG. 2D is a bottom view of an exemplary electronic device in a second state.

Referring to FIG. 2D, in the second state, one or more second image sensors 250-2 may be located outside the structure. For example, the structure may include an opening 212a. For example, in the second state, the one or more second image sensors 250-2 may be located outside the opening 212a in a first plate 212. For example, the one or more second image sensors 250-2 may be exposed through the opening 212a in a first state. For example, since the one or more second image sensors 250-2 are located outside a first housing part 210 in the second state, the one or more second image sensors 250-2 may be exposed in the second state. For example, since the one or more second image sensors 250-2 are located outside the structure in the second state, the relative positional relationship in the second state may be different from the relative positional relationship in the first state.

For example, in case the electronic device 101 does not include the structure such as the opening 212a, the one or more second image sensors 250-2 may be exposed in the second state among the first state and the second state.

Although not illustrated in FIGS. 2A, 2B, 2C, and 2D, the electronic device 101 may be in an intermediate state between the first state and the second state. For example, a size of the display area in the intermediate state may be larger than a size of the display area in the first state and smaller than a size of the display area in the second state. For example, the display area in the intermediate state may correspond to an area including an area 230a and a portion of an area 230b. For example, in the intermediate state, a portion of the area 230b is exposed, and another portion (or remaining portion) of the area 230b may be covered by the first housing part 210 or may be rollable into the first housing part 210. However, it is not limited thereto.

Referring again to FIG. 1, the electronic device 101 may include structures for moving a second housing (e.g., a second housing part 220 of FIG. 2A) of the electronic device 101 with respect to a first housing (e.g., the first housing part 210 of FIG. 2A) of the electronic device 101. For example, the structures may be exemplified through a description of FIGS. 3A and 3B.

FIGS. 3A and 3B are exploded perspective views of an exemplary electronic device.

Referring to FIGS. 3A and 3B, an electronic device 101 may include a first housing part 210, a second housing part 220, a display 230, and a driving unit 360.

For example, the first housing part 210 may include a first cover 311, a first plate 212, and a frame 313.

For example, the first cover 311 may at least partially form a side surface portion of an outer surface of the electronic device 101. For example, the first cover 311 may include an opening 311a for one or more second image sensors 250-2. For example, the first cover 311 may include a surface supporting the first plate 212. For example, the first cover 311 may be coupled to the first plate 212. For example, the first cover 311 may include the frame 313. For example, the first cover 311 may be coupled to the frame 313.

For example, the first plate 212 may at least partially form a rear surface portion of the outer surface. For example, the first plate 212 may include an opening 212a for the one or more second image sensors 250-2. For example, the first plate 212 may be disposed on the surface of the first cover 311. For example, the opening 212a may be aligned with the opening 311a.

For example, the frame 313 may be at least partially surrounded by the first cover 311.

For example, the frame 313 may be at least partially surrounded by the display 230. For example, the frame 313 is at least partially surrounded by the display 230, but a position of the frame 313 may be maintained independently of movement of the display 230. For example, the frame 313 may be arranged in relation to at least some of the components of the display 230. For example, the frame 313 may include rails 313a that provide (or guide) a path of movement of at least one component of the display 230.

For example, the frame 313 may be coupled with at least one component of the electronic device 101. For example, the frame 313 may support a battery 189. For example, the battery 189 may be supported through a recess or a hole in a surface 313b of the frame 313. For example, the frame 313 may be coupled with one end of a flexible printed circuit board (FPCB) 325 on a surface of the frame 313. For example, although not explicitly illustrated in FIGS. 3A and 3B, another end of the FPCB 325 may be connected to a PCB 324 through at least one connector. For example, the PCB 324 may be electrically connected to another PCB that supplies power to a motor 361 through the FPCB 325.

For example, the frame 313 may be coupled with at least one structure of the electronic device 101 for a plurality of states including the first state and the second state. For example, the frame 313 may fasten the motor 361 of the driving unit 360.

For example, the second housing part 220 may include a second cover 321 and a second plate 322.

For example, the second cover 321 may be at least partially surrounded by the display 230. For example, the second cover 321 may be coupled with at least a portion of an area 230a of the display 230 surrounding the second cover 321, unlike the frame 313, so that the display 230 is moved according to the second housing part 220 that is moved with respect to the first housing part 210.

For example, the second cover 321 may be coupled with the at least one component of the electronic device 101. For example, the second cover 321 may be coupled with the printed circuit board (PCB) 324 including components of the electronic device 101. For example, the PCB 324 may include a processor 120 (not illustrated in FIGS. 3A and 3B). For example, the second cover 321 may support the one or more second image sensors 250-2.

For example, the second cover 321 may be coupled with at least one structure of the electronic device 101 for a plurality of states including the first state and the second state. For example, the second cover 321 may fasten a rack gear 363 of the driving unit 360.

For example, the second cover 321 may be coupled with the second plate 322.

For example, the second plate 322 may be coupled with the second cover 321 in order to protect at least one component of the electronic device 101 coupled into the second cover 321 and/or at least one structure of the electronic device 101 coupled into the second cover 321. For example, the second plate 322 may include a structure for the at least one component. For example, the second plate 322 may include one or more openings 326 for the one or more second image sensors 250-2. For example, the one or more openings 326 may be aligned with the one or more second image sensors 250-2 disposed on the second cover 321. For example, a size of each of the one or more openings 326 may correspond to a size of each of the one or more second image sensors 250-2.

For example, the electronic device 101 may include a support member 331 for supporting at least a portion of the display 230. For example, the support member 331 may include a plurality of bars. For example, the plurality of bars may be coupled to each other. The support member 331 may support an area 230b of the display 230.

For example, the driving unit 360 may include the motor 361, a pinion gear 362, and the rack gear 363.

For example, the motor 361 may operate based on power from the battery 189. For example, the power may be provided to the motor 361 in response to the user input.

For example, the pinion gear 362 may be coupled with the motor 361 through a shaft. For example, the pinion gear 362 may be rotated based on the operation of the motor 361 transmitted through the shaft.

For example, the rack gear 363 may be arranged in relation to the pinion gear 362. For example, teeth of the rack gear 363 may engage with teeth of the pinion gear 362. For example, the rack gear 363 may be moved in a first direction 261 or a second direction 262 according to the rotation of the pinion gear 362. For example, the second housing part 220 may be moved in the first direction 261 and the second direction 262 by the rack gear 363 that is moved according to the rotation of the pinion gear 362 due to the operation of the motor 361. For example, the first state of the electronic device 101 may be changed to a state (e.g., the one or more intermediate states or the second state) different from the first state through the movement of the second housing part 220 in the first direction 261. For example, the second state of the electronic device 101 may be changed to a state (e.g., the one or more intermediate states or the first state) different from the second state through the movement of the second housing part 220 in the second direction 262. For example, that the first state is changed to the second state by the driving unit 360 and that the second state is changed to the first state by the driving unit 360 may be exemplified through FIGS. 4A and 4B.

For example, the first cover 311 may include a conductive portion (e.g., a first conductive portion 314) that may operate as an antenna radiator used for communication with an external electronic device. For example, the conductive portion may include a conductive material (e.g., metal). For example, the conductive portion may operate as an antenna radiator capable of transmitting and/or receiving a wireless signal on a designated frequency band by being fed from a wireless communication circuit (e.g., a wireless communication module 192 of FIG. 1).

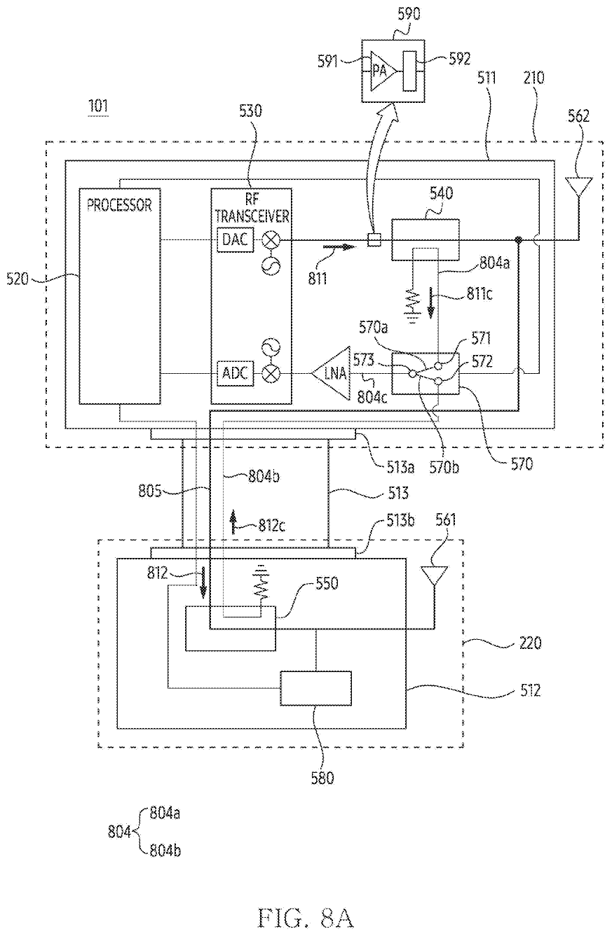

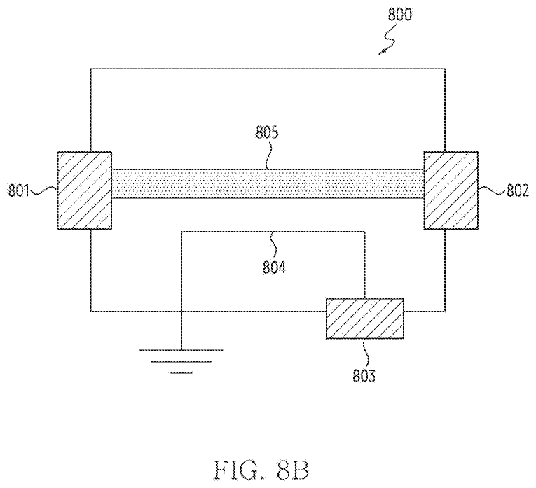

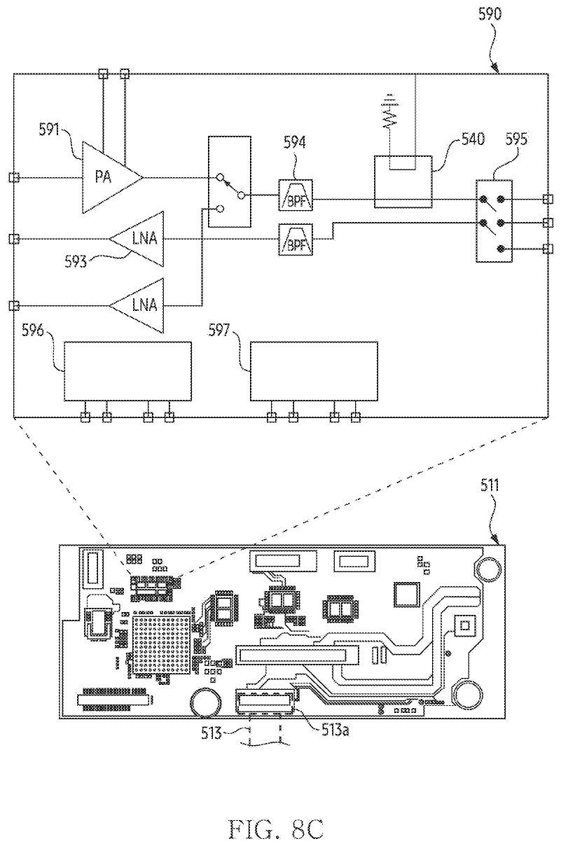

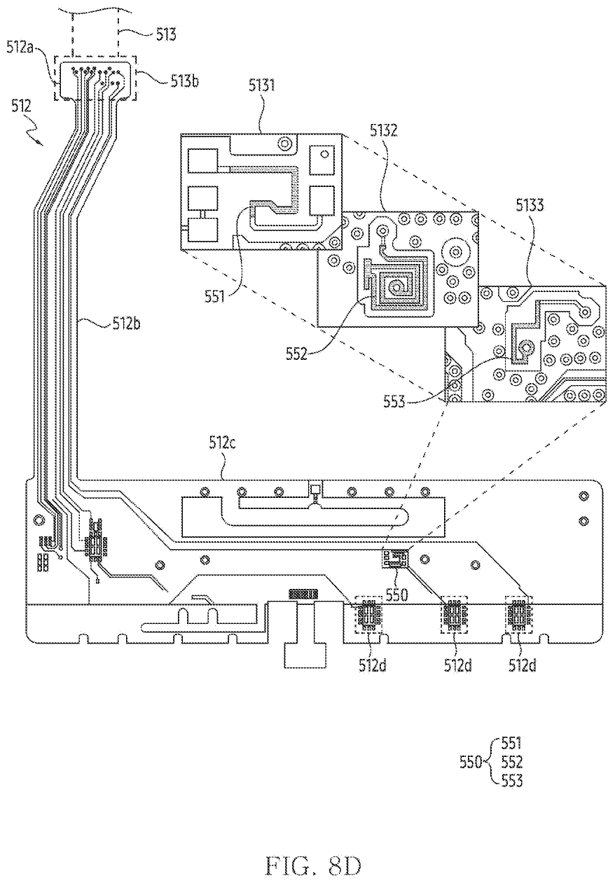

Referring to FIG. 3B, the first cover 311 may include a first conductive portion 314, a second conductive portion 315, and/or a third conductive portion 316, which cooperatively form a first surface SI facing a +z direction and a second surface S2 facing a −y direction. For example, the first cover 311 may include a first non-conductive portion 317 and a second non-conductive portion 318, which are in contact with each end of the first conductive portion 314. The first conductive portion 314 may be electrically disconnected from the second conductive portion 315 and/or the third conductive portion 316 by the first non-conductive portion 317 and the second non-conductive portion 318. For example, the first conductive portion 314 may operate as the antenna radiator for transmitting and/or receiving the wireless signal on the designated frequency band. For example, the first conductive portion 314 may be electrically connected to the another PCB. The first conductive portion 314, which may operate as the antenna radiator, may be referred to as at least a portion of an antenna (e.g., an antenna 561 of FIG. 8A) to be described later.

FIG. 4A is a cross-sectional view of an exemplary electronic device in a first state. FIG. 4B is a cross-sectional view of an exemplary electronic device in a second state.

For example, FIG. 4A is a cross-sectional view of an exemplary electronic device 101 cut along A-A′ of FIG. 2A. For example, FIG. 4B is a cross-sectional view of the exemplary electronic device 101 cut along B-B′ of FIG. 2C.

Referring to FIGS. 4A and 4B, a motor 361 may be operated based at least in part on the above-defined user input received in a state 490, which is the first state. For example, a pinion gear 362 may be rotated in a first rotation direction 411 based at least in part on the operation of the motor 361. For example, a rack gear 363 may be moved in a first direction 261 based at least in part on the rotation of the pinion gear 362 in the first rotation direction 411. For example, since a second cover 321 in a second housing part 220 fastens the rack gear 363, the second housing part 220 may be moved in the first direction 261 based at least in part on the movement of the rack gear 363 in the first direction 261. For example, since the second cover 321 in the second housing part 220 is coupled with at least a portion of an area 230a of a display 230 and fastens the rack gear 363, the display 230 may be moved based at least part on the movement of the rack gear 363 in the first direction 261. For example, the display 230 may be moved along rails 313a. For example, a shape of at least some of the plurality of bars of a support member 331 of the display 230 may be changed when the state 490 is changed to a state 495, which is the second state.

For example, an area 230b of the display 230 may be moved according to the movement of the display 230. For example, the area 230b may be moved through a space between a first cover 311 and a frame 313 when the state 490 is changed to the state 495 according to the above-defined user input. For example, the area 230b in the state 495 may be exposed, unlike the area 230b rolled into the space in the state 490.

For example, since the second cover 321 in the second housing part 220 is coupled with the PCB 324 connected to the other end of the FPCB 325 and fastens and the rack gear 363, and a shape of the FPCB 325 may be changed when the state 490 is changed to the state 495.

The motor 361 may operate based at least in part on the above-defined user input received in the state 495. For example, the pinion gear 362 may be rotated in a second rotation direction 412 based at least in part on the operation of the motor 361. For example, the rack gear 363 may be moved in a second direction 262 based at least in part on the rotation of the pinion gear 362 in the second rotation direction 412. For example, since the second cover 321 in the second housing part 220 fastens the rack gear 363, the second housing part 220 may be moved in the second direction 262 based at least in part on the movement of the rack gear 363 in the second direction 262. For example, since the second cover 321 in the second housing part 220 is coupled with at least portion of the area 230a of the display 230 and fastens the rack gear 363, the display 230 may be moved based at least part on the movement of the rack gear 363 in the second direction 262. For example, the display 230 may be moved along the rails 313a. For example, the shape of at least some of the plurality of bars of the support member 331 of the display 230 may be changed when the state 495 is changed to the state 490. The support member 331 may be moved with respect to a first housing part 210. The support member 331 stored inside the first housing part 210 in the state 490 may be located between the first cover 311 and the frame 313. The display 230 may be moved with respect to the first housing part 210 according to the movement of the support member 331.

For example, the area 230b of the display 230 may be moved according to the movement of the display 230. For example, when the state 495 is changed to the state 490 according to the above-defined user input, the area 230b may be moved through a space between the first cover 311 and the frame 313. For example, the area 230b in the state 490 may be rolled into the space, unlike the area 230b exposed in the state 495.

For example, since the second cover 321 of the second housing part 220 is coupled with the PCB 324 connected to the other end of the FPCB 325 and fastens the rack gear 363, the shape of the FPCB 325 may be changed when the state 495 is changed to the state 490.

FIG. 5A illustrates the inside of an exemplary electronic device in a first state. FIG. 5B illustrates the inside of an exemplary electronic device in a second state. FIG. 5C is an exploded perspective view of an exemplary electronic device.

Referring to FIGS. 5A, 5B, and 5C, an exemplary electronic device 101 may include a housing 201, a first substrate 511, a second substrate 512, and a third substrate 513.

For example, the housing 201 may include a first housing part 210 and a second housing part 220 that are movably coupled to each other. For example, the first housing part 210 may be movably coupled to the second housing part 220 in a first direction 261 and a second direction 262. However, it is not limited thereto. For example, “that the first housing part 210 is movably coupled to the second housing part 220” may be referred to as that a relative position with respect to each other of the first housing part 210 and the second housing part 220 is changed. The first housing part 210 and the second housing part 220 may be referred to as the first housing part 210 and the second housing part 220 described with reference to FIGS. 2A to 4B. A state (e.g., a slide-in state) in which the second housing part 220 is movable in the first direction 261 may be referred to as the first state illustrated in FIGS. 2A and 5A. A state (e.g., a slide-out state) in which the second housing part 220 is movable in the second direction 262 may be referred to as the second state illustrated in FIGS. 2B and 5B. The first state may be referred to as a reduced state in terms of providing the housing 201 having the smallest size. The second state may be referred to as an expanded state in terms of providing the housing 201 having the largest size. However, it is not limited thereto. For example, the electronic device 101 may be in any one of a plurality of intermediate states between the first state and the second state. The plurality of intermediate states may mean a state between the first state in which a size of the housing 201 is minimum and the second state in which the a of the housing 201 is maximum. For example, in the plurality of intermediate states, the size of the housing 201 may be larger than the size of the housing 201 in the first state and may be smaller than the size of the housing 201 in the second state.

For example, the first substrate 511, the second substrate 512, and the third substrate 513 may be configured to provide electrical connection between components of the electronic device 101. For example, the first substrate 511 and the second substrate 512 may include a printed circuit board. For example, the first substrate 511 and the second substrate 512 may include a plurality of conductive layers and a plurality of non-conductive layers alternately laminated with the plurality of conductive layers. The first substrate 511 and the second substrate 512 may provide electrical connections between various electronic components by using wires and conductive vias formed in the conductive layer.

The electronic device 101 may include a plurality of electronic components for various functions. The plurality of electronic components may be disposed in the first housing part 210 and the second housing part 220. As the first housing part 210 and the second housing part 220 are movably coupled to each other, an electrical connection between at least one electronic component (e.g., a processor 120 of FIG. 1) disposed in the first housing part 210 and at least one electronic component (e.g., an antenna 561 of FIG. 8A) disposed in the second housing part 220 may be required. That a component is disposed in the first housing part 210 or the second housing part 220 may be referred to as a structure in which the component is disposed inside the first housing part 210 or the second housing part 220 or a structure that is supported by the first housing part 210 or the second housing part 220. However, it is not limited thereto.

For example, the first substrate 511 may be disposed on the second housing part 220. For example, the second housing part 220 may include a second cover 321. For example, the first substrate 511 may be disposed on the second cover 321. The first substrate 511 may be electrically connected to at least one electronic component of the second housing part 220. For example, at least one processor 520 (e.g., the processor 120 of FIG. 1) and/or a wireless communication circuit (e.g., a wireless communication module 192 of FIG. 1) may be disposed on the first substrate 511.

For example, the second substrate 512 may be disposed on the first housing part 210. For example, the first housing part 210 may include a first cover 311 and a frame 313. For example, the second substrate 512 may be disposed on one surface 210a of the first cover 311 of the first housing part 210. In order to provide a space in which at least a portion of the second housing part 220 and/or at least a portion of a display (e.g., a display 230 of FIG. 5C) may be located inside the first housing part 210, the third substrate 513 may be disposed on the one surface 210a of the first housing part 210 rather than inside the first housing part 210. The second substrate 512 may be electrically connected to at least one electronic component of the first housing part 210. For example, the second substrate 512 may be electrically connected to an antenna (e.g., the antenna 561 of FIG. 8A). For example, the antenna 561 may include a first conductive portion 314 illustrated in FIGS. 3A and 3B. However, it is not limited thereto. For example, the antenna 561 may include a separate antenna module that is distinct from the first conductive portion 314.

For example, the third substrate 513 may electrically connect the first substrate 511 and the second substrate 512. For example, the third substrate 513 may include a flexible printed circuit board and/or a flexible printed circuit board radio frequency cable (FRC). The third substrate 513 may provide a path for an electrical signal (e.g., an RF signal) between the first substrate 511 and the second substrate 512, by electrically connecting the first substrate 511 and the second substrate 512. For example, an electrical signal provided from at least one electronic component disposed on the first substrate 511 may be transmitted to at least one electronic component disposed on the second substrate 512 through the third substrate 513.

For example, the third substrate 513 may be connected to the second substrate 512. However, it is not limited thereto. The third substrate 513 may be directly connected to the second substrate 512 or indirectly connected through a fourth substrate 514 electrically connected to the second substrate 512. For example, the fourth substrate 514 may be disposed between the first substrate 511 and the second substrate 512. For example, the electrical signal provided from the first substrate 511 may be provided to the second substrate 512 through the third substrate 513 and the fourth substrate 514.

For example, the electronic device 101 may include a driving unit 360. The driving unit 360 may be configured to provide a driving force that changes a shape of the housing 201. For example, the driving unit 360 may include a motor 361, a rack gear 363, and/or a pinion gear 362. For example, the motor 361 may operate based on power provided from a battery. The pinion gear 362 may be coupled to the motor 361 through a shaft. For example, the pinion gear 362 may be rotated based on a rotational operation of the motor 361 transmitted through the shaft. For example, the rack gear 363 may move based on the rotation of the pinion gear 362 by engaging with the pinion gear 362. For example, teeth of the rack gear 363 may engage with teeth of the pinion gear 362. As the pinion gear 362 rotates, the pinion gear 362 may move the rack gear 363 in a first direction 261 or a second direction 262. For example, the rack gear 363 may be configured to move in the first direction 261 or the second direction 262, based on a rotation direction of the pinion gear 362.

Referring to FIG. 5C, the display 230 may include a first display area 230a and a second display area 230b. The first display area 230a may be a portion of the display 230 that may always be visually recognized from outside, independent of a state of the electronic device 101. For example, regardless of whether the electronic device 101 is in the first state or the second state, the first display area 230a may be a flat planar portion. The second display area 230b may be a bendable portion that may be at least partially deformed according to movement of the second housing part 220. For example, the display 230 may be coupled to the second housing part 220. The display 230 may be configured to move based on the movement of the second housing part 220.

In the first state, at least a portion of the second display area 230b may be rollable into the first housing part 210. In the second state, the at least a portion of the second display area 230b may be unfolded. As the display 230 moves, a position of the second display area 230b may be changed. For example, in the first state, the second display area 230b may be located inside the first housing part 210. For example, in the second state, the at least a portion of the second display area 230b may be located outside the first housing part 210. When the second display area 230b is located outside the first housing part 210, the second display area 230b is unfolded, so that a display area of the display 230 may be expanded. For example, the first display area 230a may be referred to as the above-described area (e.g., the area 230a of FIG. 2A), and the second display area 230b may be referred to as the above-described area (e.g., the area 230b of FIG. 2C).

Referring to FIGS. 5A and 5B, as a structure of the housing 201 is changed by the driving unit 360, a distance between the first substrate 511 and the second substrate 512 may be changed. A change in the distance between the first substrate 511 and the second substrate 512 may cause deformation of a shape of the third substrate 513. The electrical signal transmitted through the third substrate 513 may be affected by the deformation of the shape of the third substrate 513.

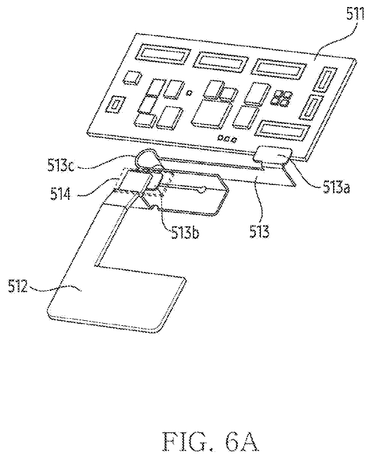

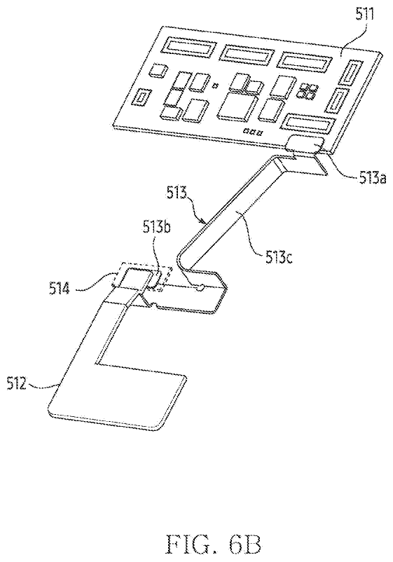

FIG. 6A illustrates a first substrate, a second substrate, and a third substrate, in a first state. FIG. 6B illustrates a first substrate, a second substrate, and a third substrate, in a second state.

Referring to FIGS. 6A and 6B, a third substrate 513 may be deformed based on movement of a first housing part (e.g., a first housing part 210 of FIG. 5A) or a second housing part (e.g., a second housing part 220 of FIG. 5A). For example, the third substrate 513 may be flexible. For example, a portion 513c of the third substrate 513 between a first connector 513a coupled to a first substrate 511 and a second connector 513b coupled to a second substrate 512 may be bent or unfolded based on the movement of the first housing part 210 or the second housing part 220.

For example, the third substrate 513 may include the first connector 513a and the second connector 513b. The first connector 513a may be fixed by being connected to the first substrate 511. The second connector 513b may be fixed by being connected to the second substrate 512. Since the first connector 513a is fixed to the first substrate 511 and the second connector 513b is fixed to the second substrate 512, a relative positional relationship between the first connector 513a and the second connector 513b may be changed when the first housing part 210 or the second housing part 220 moves. As the fixed relative position between the first connector 513a and the second connector 513b is changed, a shape of the portion 513c of the third substrate 513 between the first connector 513a and the second connector 513b may be deformed. However, it is not limited thereto. For example, the second connector 513b may be fixed by being connected to a fourth substrate 514 electrically connected to the second substrate 512.

Referring to FIG. 6A, in the first state, the portion 513c of the third substrate 513 between the first connector 513a and the second connector 513b may be bent. Referring to FIG. 6B, in the second state, the portion 513c of the third substrate 513 may be unfolded. In the second state, the portion 513c of the third substrate 513 may be flat.

As a state of an electronic device (e.g., an electronic device 101 of FIG. 5A) changes repeatedly, a shape of the third substrate 513 may change repeatedly. For example, when the electronic device 101 is changed from the first state to the second state, the portion 513c of the third substrate 513 may is changed from a bent state to a flat state. For example, when the electronic device 101 is changed from the second state to the first state, the portion 513c of the third substrate 513 may be changed from the bent state to the flat state. For example, when the electronic device 101 is in an intermediate state, the portion 513c of the third substrate 513 may be bent, slightly bent or slightly straight. An angle at which the portion 513c of the third substrate 513 is bent in the intermediate state may be smaller than an angle at which the portion 513c of the third substrate 513 is bent in the first state. The angle at which the portion 513c of the third substrate 513 is bent may be a maximum in the first state. The angle at which the portion 513c of the third substrate 513 is bent may be minimum in the second state. In a plurality of intermediate states, the angle at which the portion 513c of the third substrate 513 is bent may be smaller than the angle in the first state and greater than the angle in the second state.

For example, referring to FIG. 6A, in the first state, the portion 513c of the third substrate 513 between the first connector 513a and the second connector 513b may be at least partially bent. As the first substrate 511 and the second substrate 512 become closer, a gap between the first substrate 511 and the second substrate 512 may be reduced. In the first state, the portion 513c of the third substrate 513 is bent, so that the third substrate 513 may be disposed between the first substrate 511 and the second substrate 512. For example, referring to FIG. 6B, in the second state, the portion 513c of the third substrate 513 may become at least partially flat. For example, in the second state, the portion 513c of the third substrate 513 may include a flat portion 513d and a bent portion 513c. For example, the third substrate 513c may include a rigid-flexible PCB (RF-PCB) that includes both a rigid portion and a flexible portion. For example, the portion of the third substrate 513 that is bent based on a state of the electronic device 101 may be flexible, and the portion of the third substrate 513 that is always flat regardless of the state of the electronic device 101 may be rigid. However, it is not limited thereto.

The third substrate 513 may include a signal line for an electrical signal. The signal line may include an RF signal line for a radio frequency (RF) signal. The shape of the portion 513c of the third substrate 513 may affect an electrical signal transmitted through the signal line of the third substrate 513. For example, a signal line for a transmission path of the electrical signal of the third substrate 513 disposed between the first substrate 511 and the second substrate 512 may have different electrical characteristics based on the shape of the third substrate 513. For example, based on the angle at which the portion 513c of the third substrate 513 is bent, an impedance of the RF signal line formed in the third substrate 513 may change.

For example, when the RF signal is transmitted and/or received through an antenna electrically connected to the second substrate 512, an electrical characteristic (e.g., the impedance) of the RF signal may be changed as the RF signal passes through the third substrate 513. For example, a wireless communication circuit (e.g., a wireless communication module 192 of FIG. 1) may be disposed on the first substrate 511 and may radiate the RF signal through the antenna (e.g., a first conductive portion 314 of FIG. 3B and/or an antenna 561 of FIG. 8A) electrically connected to the second substrate 512. The RF signal may be provided to the antenna through the first substrate 511, the third substrate 513, the fourth substrate 514, and the second substrate 512. For example, the RF signal received through the antenna electrically connected to the second substrate 512 may be provided to the wireless communication circuit 192 through the second substrate 512, the fourth substrate 514, the third substrate 513, and the first substrate 511. Since the electrical path through which the RF signal is transmitted includes the third substrate 513 that may be at least partially bent according to the state of the electronic device 101, the RF signal transmitted and/or received through the electronic device 101 may be affected by the impedance of the RF signal line formed in the third substrate 513.

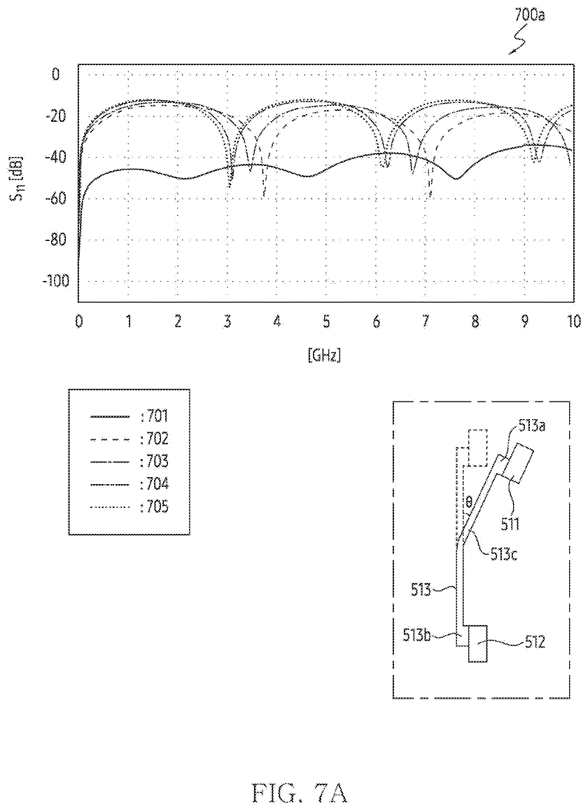

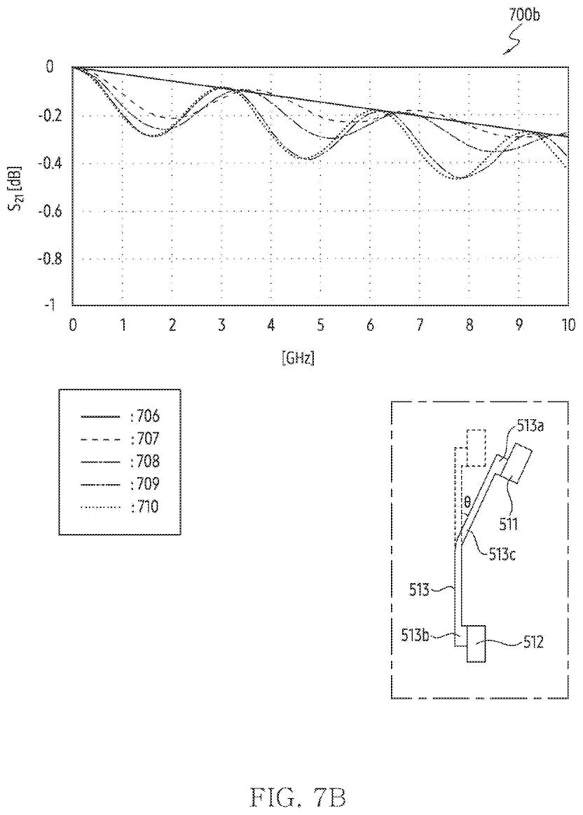

FIG. 7A is a graph illustrating a reflection coefficient of an RF signal according to an angle of a portion of a third substrate. FIG. 7B is a graph illustrating a transmission coefficient of an RF signal according to an angle of a portion of a third substrate.

An x-axis of graphs 700a and 700b is frequency (unit: giga hertz (GHz)) and a y-axis is S-parameter (unit: decibel (dB)).

Referring to the graph 700a in FIG. 7A, according to an angle at which a portion (e.g., a portion 513c of FIG. 6A) of the third substrate (e.g., a third substrate 513 of FIG. 6A) between a first connector (e.g., a first connector 513a of FIG. 6A) and a second connector (e.g., a second connector 513b of FIG. 6A) is bent, the reflection coefficient of the RF signal flowing along an RF signal line of the third substrate 513 may vary. The reflection coefficient may be referred to as a parameter indicating a degree to which power provided to a load (e.g., an antenna 561 of FIG. 8A) through the RF signal line is reflected without being radiated. For example, the angle may be referred to as a bending angle θ of the portion 513c of the third substrate 513 between the first connector 513a and the second connector 513b, which is changed according to a change in a relative positional relationship between a first substrate 511 and a second substrate 512.

For example, a first graph 701 indicates the reflection coefficient of the RF signal flowing along the RF signal line when the portion 513c of the third substrate 513 is in a flat state (e.g., a second state). For example, a second graph 702 indicates the reflection coefficient of the RF signal flowing along the RF signal line when the angle of the portion 513c of the third substrate 513 is about 0.4 degrees. For example, a third graph 703 indicates the reflection coefficient of the RF signal flowing along the RF signal line when the angle of the portion 513c of the third substrate 513 is about 1 degree. For example, a fourth graph 704 indicates the reflection coefficient of the RF signal flowing along the RF signal line when the angle of the portion 513c of the third substrate 513 is about 6 degrees. For example, a fifth graph 705 indicates the reflection coefficient of the RF signal flowing along the RF signal line when the angle of the portion 513c of the third substrate 513 is about 30 degrees.

Referring to FIG. 7A, as the angle of the portion 513c of the third substrate 513 increases, the reflection coefficient may increase. For example, the reflection coefficient of the RF signal indicated by the first graph 701 may be the lowest. For example, the reflection coefficient of the RF signal indicated by the fifth graph 705 may be the highest. When an electronic device 101 is changed from the second state to an intermediate state or a first state, the angle of the portion 513c of the third substrate 513 may be increased as the portion 513c of the third substrate 513 is bent. As the reflection coefficient increases according to the angle of the portion 513c of the third substrate 513, radiation performance of the antenna 561 may deteriorate.

Referring to the graph 700b in FIG. 7B, according to an angle at which the portion 513c of the third substrate 513 between the first connector 513a and the second connector 513b is bent, the transmission coefficient of the RF signal flowing along the RF signal line of the third substrate 513 may vary. The transmission coefficient may be referred to as a parameter indicating a degree to which the power provided to the load (e.g., the antenna 561) through the RF signal line passes through the RF signal line. For example, the angle may be referred to as the bending angle θ of the portion 513c of the third substrate 513 between the first connector 513a and the second connector 513b, which is changed according to the change in the relative positional relationship between the first substrate 511 and the second substrate 512.

For example, a first graph 706 indicates the transmission coefficient of the RF signal flowing along the RF signal line when the portion 513c of the third substrate 513 is in the flat state (e.g., the second state). For example, a second graph 707 indicates the transmission coefficient of the RF signal flowing along the RF signal line when the angle of the portion 513c of the third substrate 513 is about 0.4 degrees. For example, a third graph 708 indicates the transmission coefficient of the RF signal flowing along the RF signal line when the angle of the portion 513c of the third substrate 513 is about 1 degree. For example, a fourth graph 709 indicates the transmission coefficient of the RF signal flowing along the RF signal line when the angle of the portion 513c of the third substrate 513 is about 6 degrees. For example, a fifth graph 710 indicates the transmission coefficient of the RF signal flowing along the RF signal line when the angle of the portion 513c of the third substrate 513 is about 30 degrees.

Referring to FIG. 7B, as the angle of the portion 513c of the third substrate 513 increases, the transmission coefficient may decrease. For example, the transmission coefficient of the RF signal indicated by the first graph 706 may be the highest. For example, the transmission coefficient of the RF signal indicated by the fifth graph 710 may be the lowest. When the electronic device 101 is changed from the second state to the intermediate state or the first state, the angle of the portion 513c of the third substrate 513 may be increased as the portion 513c of the third substrate 513 is bent. As the transmission coefficient decreases according to the angle of the portion 513c of the third substrate 513, the radiation performance of the antenna 561 may deteriorate.

An RF signal (e.g., a transmission signal) to be transmitted to an external electronic device may be provided from the first substrate 511 to the second substrate 512 through the third substrate 513. The RF signal may be transmitted to the external electronic device by being provided to the antenna 561 electrically connected to the second substrate 512. When the RF signal passes through the third substrate 513, an electrical characteristic of the RF signal may change according to the angle at which the portion 513c of the third substrate 513 is bent. The electronic device 101 may reduce deterioration of communication performance by identifying the difference in an electrical characteristic between a signal (e.g., a first signal 811 of FIG. 8A) before passing through the third substrate 513 and a signal (e.g., a second signal 812 of FIG. 8A) after passing through the third substrate 513 and by compensating for the difference.

FIG. 8A is a schematic block diagram of an exemplary electronic device. FIG. 8B illustrates an exemplary single directional coupler. FIG. 8C illustrates an exemplary first substrate. FIG. 8D illustrates an exemplary second substrate.

As described above, as the angle increases, a reflection coefficient of an RF signal may increase and a transmission coefficient may decrease. For example, as an angle at which a portion of a third substrate (e.g., a third substrate 513 of FIG. 6A) is bent increases, a loss of a signal due to a change in an impedance may increase. When the RF signal passes through the third substrate 513, as a loss of the RF signal occurs, performance deterioration of an electronic device 101 may be caused. For example, as an electrical characteristic of the RF signal for communication with an external electronic device change as it passes through the third substrate 513, communication performance of the electronic device 101 may deteriorate.

The exemplary electronic device 101 may include components for improving the communication performance of the electronic device 101 by identifying an electrical characteristic deviation caused by the RF signal passing through the third substrate 513 and by compensating for the deviation. Hereinafter, the exemplary electronic device 101 capable of compensating for the characteristic deviation of the RF signal by the third substrate 513 will be described with reference to drawings.

Referring to FIG. 8A, the exemplary electronic device 101 may include at least one processor 520, an RF transceiver 530, a first coupler 540, a second coupler 550, and/or an antenna 561.

For example, the at least one processor 520, the RF transceiver 530, and the first coupler 540 may be disposed on a first substrate 511. As described above, the first substrate 511 may be disposed on a first housing part 210. For example, the second coupler 550 may be disposed on a second substrate 512. As described above, the second substrate 512 may be disposed on one surface 210a of a second housing part 220. The third substrate 513 may be disposed between the first substrate 511 and the second substrate 512. The antenna 561 may be electrically connected to the second substrate 512. For example, an antenna radiator for transmitting and/or receiving a signal may be electrically connected to the second substrate 512. For example, the antenna 561 may be referred to as a first conductive portion (e.g., a first conductive portion 314 of FIG. 3B) illustrated in FIG. 3B, but is not limited thereto.

For example, the at least one processor 520 may include at least one of an application processor (AP) (e.g., a main processor 121 of FIG. 1) or a communication processor (CP) (e.g., an auxiliary processor 123 of FIG. 1). For example, a processor may include the AP and the CP. For example, the at least one processor 520 may include the AP. For example, the at least one processor 520 may include the CP.

The at least one processor 520 may generate a baseband signal. The at least one processor 520 may control the RF transceiver 530 to process the generated baseband signal. The at least one processor 520 may output a transmission signal with designated transmission power. For example, the transmission signal may mean a communication signal for being transmitted to the external electronic device (e.g., a base station, another terminal). The at least one processor 520 may control the RF transceiver 530 so that the transmission signal is transmitted through the antenna 561. The at least one processor 520 may control the RF transceiver 530 so that the transmission signal is transmitted in a frequency band capable of communicating with the external electronic device.

For example, the RF transceiver 530 may be implemented as a single chip (e.g., a radio frequency integrated circuit (RFIC) chip) or as a portion of a single package. The RF transceiver 530 may include a digital to analog converter (DAC) for converting a digital signal into an analog signal. The RF transceiver 530 may include a mixer and an oscillator (e.g., a local oscillator (LO)) for up-conversion. The RF transceiver 530 may convert the baseband signal generated by the at least one processor 520 into the RF signal. The RF transceiver 530 may include an analog to digital converter (ADC) for converting the analog signal into the digital signal. The RF transceiver 530 may include a mixer and an oscillator for down-conversion. The RF transceiver 530 may convert the RF signal received from the antenna 561 into the baseband signal so that it may be processed by the at least one processor 520. The RF transceiver 530 may transmit and/or receive the RF signal through an RF signal line 805.

For example, the electronic device 101 may include a power amplifier module (PAM) 590. For example, the PAM 590 may include a power amplifier (PA) 591 and/or a duplexer 592 for a transmission path, but is not limited thereto.

For example, the RF transceiver 530 may receive coupling signals fed back from the first coupler 540 and the second coupler 550. For example, the RF transceiver 530 may include a feedback receive port (FBRX). For example, the RF transceiver 530 may receive a first coupling signal 811c provided from the first coupler 540 and a second coupling signal 812c provided from the second coupler 550 at different times. The electronic device 101 may include components for receiving the first coupling signal 811c and the second coupling signal 812c. For example, the components may include a low noise amplifier (LNA), an ADC, a mixer, and an oscillator.

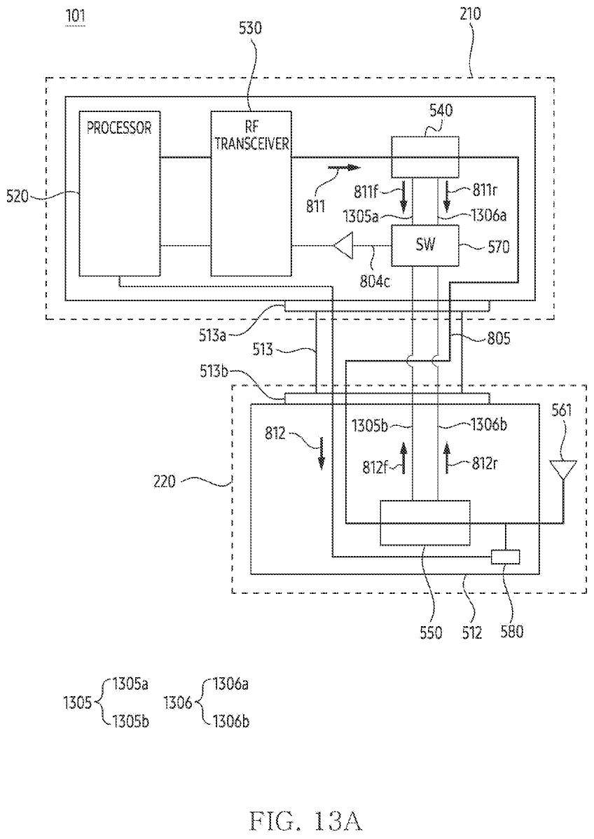

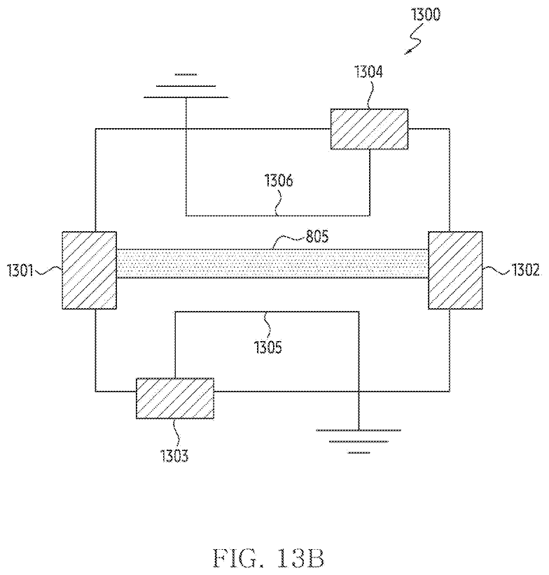

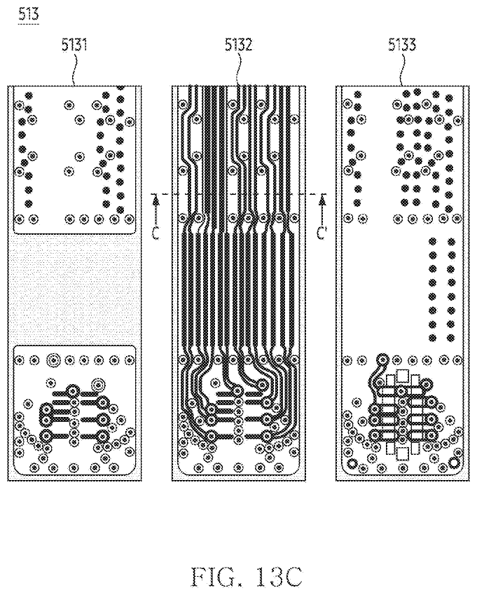

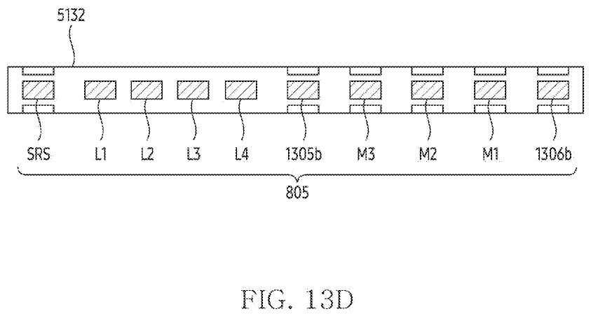

For example, the first coupler 540 and the second coupler 550 may be single directional couplers. However, it is not limited thereto. The first coupler 540 and the second coupler 550 may each be a dual directional coupler. An example in which the first coupler 540 and the second coupler 550 are implemented as dual directional couplers will be described later with reference to FIG. 13A.

For example, the first coupler 540 and the second coupler 550 may mean RF passive elements for distributing or coupling signal power. Referring to FIG. 8B, a single directional coupler 800 may include three ports. The three ports may include a first port 801 for inputting the transmission signal, a second port 802 for outputting the transmission signal, or a third port 803 for coupling. For example, the single directional coupler 800 may be a 3-port coupler. The single directional coupler 800 may include a portion of the RF signal line 805 for power transmission between the first port 801 and the second port 802. The first port 801 may be referred to as an input port. The second port 802 may be referred to as an output port. The single directional coupler 800 may include a coupling signal line 804 connected to the third port 803 and adjacent to the RF signal line 805. Through the coupling signal line 804, the single directional coupler 800 may transmit power to the third port 803 or may obtain power from the third port 803. The third port 803 may be referred to as a coupling port. According to an embodiment, the single directional coupler 800 may output a signal applied through the third port 803 and a signal applied through the first port 801 together through the second port 802.

Referring again to FIG. 8A, the coupling signal line 804 may include a first coupling signal line 804a and a second coupling signal line 804b. For example, the first coupler 540 may be disposed on the first substrate 511. For example, the first coupler 540 may be configured to provide the first coupling signal 811c based on a first signal 811 from the RF transceiver 530. The first coupling signal 811c may be a coupling signal for the first signal 811, which is a transmission signal before passing through the third substrate 513. The first coupler 540 may provide the first coupling signal 811c to the RF transceiver 530 through the first coupling signal line 804a.

For example, the second coupler 550 may be disposed on the second substrate 512 spaced apart from the first substrate 511. For example, the second coupler 550 may be configured to provide the second coupling signal 812c based on a second signal 812 transmitted from the third substrate 513. The second coupling signal 812c may be a coupling signal for the second signal 812, which is a transmission signal after passing through the third substrate 513. The second coupler 550 may provide the second coupling signal 812c to the RF transceiver 530 through the second coupling signal line 804b. However, it is not limited thereto.

When the transmission signal is provided from the at least one processor 520 to the antenna 561, the transmission signal may pass through the third substrate 513. According to a shape of the third substrate 513, a signal disadvantage (e.g., a loss) may occur due to an impedance of the RF signal line 805 in the third substrate 513. For example, a difference between an electrical characteristic of the first signal 811 and an electrical characteristic of the second signal 812 may occur. Due to the above difference, the electronic device 101 may not have targeted communication performance. For example, as power of the transmission signal decreases, quality of the transmission signal may deteriorate. In order to obtain a parameter indicating the electrical characteristic of the first signal 811, and a parameter indicating the electrical characteristic of the second signal 812, the electronic device 101 may include the first coupler 540 disposed on the first substrate 511 and the second coupler 550 disposed on the second substrate 512. In FIG. 8A, the first coupler 540 is illustrated as a separate component from a power amplifier module (PAM) 590, but is not limited thereto. For example, the first coupler 540 may be included in the PAM 590.

FIG. 8C indicates an example of the first substrate 511 on which components illustrated in FIG. 8A are disposed. The first substrate 511 illustrated in FIG. 8C is only exemplary and is not limited thereto.

Referring to FIGS. 8A and 8C, the first coupler 540 may be disposed in the PAM 590 that includes a plurality of components (e.g., a power amplifier 591, at least one low noise amplifier (LNA) 593, at least one filter 594, a switching circuit 595, a reception interface 596 and/or a transmission interface 597). For example, the first coupler 540 may be disposed between an output end of the power amplifier 591 and a first connector 513a in order to provide the RF transceiver 530 with a first coupling signal (e.g., the first coupling signal 811c of FIG. 8A), which is a coupling signal of a first signal (e.g., the first signal 811 of FIG. 8A) from an RF transceiver (e.g., the RF transceiver 530 of FIG. 8A). For example, the first coupler 540 may reduce a loss of the first signal 811 provided to the first coupler 540 by being disposed between the output end of the power amplifier 591 and the first connector 513a. For example, the first coupler 540 may be connected to an output end of the filter 594 in consideration of an insertion loss caused by the filter (e.g., a band pass filter (BPF)) 594. As the first coupler 540 is disposed in the PAM 590, a mounting space (or a mounting area) occupied by the first coupler 540 may be reduced.

FIG. 8D indicates an example of the second substrate 512 on which the components illustrated in FIG. 8A arc disposed. The second substrate 512 illustrated in FIG. 8D is only exemplary and is not limited thereto.

Referring to FIGS. 8A and 8D, the second coupler 550 may be disposed between a second connector 513b and an antenna (e.g., the antenna 561 of FIG. 8A) on the second substrate 512. The second coupler 550 may be disposed between a first portion 512a of the second substrate 512 connected to the second connector 513b and at least one fourth portion 512d of the second substrate 512 connected to the antenna 561, in order to provide a second coupling signal (e.g., the second coupling signal 812c of FIG. 8A), which is a coupling signal of a second signal (e.g., the second signal 812 of FIG. 8A) from the third substrate 513, to the RF transceiver (e.g., the RF transceiver 530 of FIG. 8A). For example, the second coupler 550 may obtain the second signal 812 before the second signal 812 is transmitted to the antenna 561 electrically connected to the second substrate 512, by being disposed between the second connector 513b and the antenna 561. For example, in order to provide information on an impedance of an RF signal line (e.g., the RF signal line 805 of FIG. 8A) of the third substrate 513 through the second coupling signal 812c, the second coupler 550 may be disposed close to the second connector 513b. For example, in order to provide information on an impedance by an antenna switching circuit (e.g., an antenna switching circuit 580 of FIG. 8A) through the second coupling signal 812c, the second coupler 550 may be disposed close to the antenna switching circuit 580.

For example, since the second substrate 512 may be disposed on one surface (e.g., the one surface 210a of FIG. 5C) of the first housing part (e.g., the first housing part 210 of FIG. 5C), a thickness of the second coupler 550 may be limited. In order to reduce the thickness of the second coupler 550, the second coupler 550 may include a conductive pattern embedded in the second substrate 512. As the second coupler 550 is not disposed on the second substrate 512 as the separate component but is implemented as the conductive pattern embedded in the second substrate 512, the thickness of the second coupler 550 may be reduced.

For example, as illustrated in FIG. 8D, the second coupler 550 may be formed with at least one conductive pattern disposed on a plurality of layers 5131, 5132, and 5133 of the second substrate 512. For example, the second substrate 512 may include the plurality of layers 5131, 5132, and 5133 laminated on each other. For example, the third substrate 513 may include the first layer 5131, the second layer 5132, and/or the third layer 5133. However, it is not limited thereto. The second coupler 550 is not mounted in a form of a direct circuit on the second substrate 512 but may be formed in a form of at least one conductive pattern embedded on the first layer 5131, the second layer 5132, and/or the third layer 5133 laminated on each other. For example, the second coupler 550 may be formed of at least one of a first conductive pattern 551 disposed on the first layer 5131, a second conductive pattern 552 disposed on the second layer 5132, and/or a third conductive pattern 553 disposed on the third layer 5133 or a combination thereof. The first conductive pattern 551, the second conductive pattern 552, and/or the third conductive pattern 553 may be laminated on each other.

As another example, the second coupler 550 may be formed of multiple first conductive patterns 551 disposed on multiple portions of the first layer 5131, multiple second conductive patterns 552 disposed on multiple portions of the second layer 5132, and/or multiple third conductive patterns 553 disposed on multiple portions of the third layer 5133 or combinations thereof. The multiple first conductive patterns 551, the multiple second conductive patterns 552, and/or the multiple third conductive patterns 553 may be laminated on each other.

Referring to FIG. 8D, the second substrate 512 may include the first portion 512a, a second portion 512b, a third portion 512c, and/or the at least one fourth portion 512d. The first portion 512a may be a portion of the second substrate 512 connected to the second connector 513b. The second portion 512b may be a portion of the second substrate 512 on which a plurality of signal lines extend. The third portion 512c may be a portion of the second substrate 512 on which at least one electronic component (e.g., the second coupler 550 and/or the antenna switching circuit 580) is disposed. The at least one fourth portion 512d may be a portion of the second substrate 512 including at least one contact portion connected to the antenna (e.g., the antenna 561 of FIG. 8A).

For example, the electronic device 101 may further include a switching circuit 570 (see FIG. 8A). The switching circuit 570 may be disposed on the first substrate 511. The switching circuit 570 may electrically connect the RF transceiver 530 and the first coupler 540. The switching circuit 570 may electrically connect the RF transceiver 530 and the second coupler 550. For example, the switching circuit 570 may be connected to the first coupling signal line 804a, the second coupling signal line 804b, and a third coupling signal line 804c between the RF transceiver 530 and the switching circuit 570. For example, the switching circuit 570 may include a first terminal 571 connected to the first coupling signal line 804a, a second terminal 572 connected to the second coupling signal line 804b, and a third terminal 573 connected to the third coupling signal line 804c.

For example, the RF transceiver 530 may be configured to receive the first coupling signal 811c by being electrically connected to the first coupler 540 through the switching circuit 570. For example, an electrical connection between the RF transceiver 530 and the first coupler 540 may be formed through a state 570a of the switching circuit 570 electrically connecting the first terminal 571 of the first switching circuit 570 and the third terminal 573 of the first switching circuit 570. In the state 570a of the switching circuit 570 in which the first terminal 571 and the third terminal 573 are electrically connected, the first coupling signal 811c provided from the first coupler 540 may be provided to the RF transceiver 530 through the first coupling signal line 804a and the third coupling signal line 804c.

For example, the RF transceiver 530 may be configured to receive the second coupling signal 812c by being electrically connected to the second coupler 550 through the switching circuit 570. For example, an electrical connection between the RF transceiver 530 and the second coupler 550 may be formed through a state 570b of the switching circuit 570 electrically connecting the second terminal 572 of the first switching circuit 570 and the third terminal 573 of the first switching circuit 570. In the state 570b of the switching circuit 570 in which the second terminal 572 and the third terminal 573 are electrically connected, the second coupling signal 812c provided from the second coupler 550 may be provided to the RF transceiver 530 through the second coupling signal line 804b and the third coupling signal line 804c.

For example, the at least one processor 520 may be configured to control the switching circuit 570. The at least one processor 520 may control the switching circuit 570 so that the first coupling signal 811c and the second coupling signal 812c are provided at different time. For example, the at least one processor 520 may control the switching circuit 570 so that the first terminal 571 and the third terminal 573 are electrically connected (e.g., the state 570a). In the state 570, the at least one processor 520 may receive the first coupling signal 811c. After receiving the first coupling signal 811c, the at least one processor 520 may control the switching circuit 570 so that the second terminal 572 and the third terminal 573 are electrically connected (e.g., the state 570b). In the state 570b, the at least one processor 520 may receive the second coupling signal 812c. However, it is not limited thereto.

The RF transceiver 530 may include the analog to digital converter (ADC) for converting the first coupling signal 811c and the second coupling signal 812c into digital signals.

The RF transceiver 530 may include a mixer and an oscillator for down-conversion of the first coupling signal 811c and the second coupling signal 812c. The RF transceiver 530 may down-convert the received first coupling signal 811c and the second coupling signal 812c and may convert it into the digital signal. The RF transceiver 530 may provide the converted first coupling signal 811c and the second coupling signal 812c to the at least one processor 520.

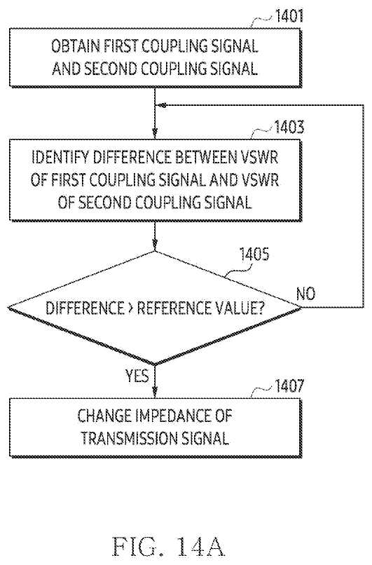

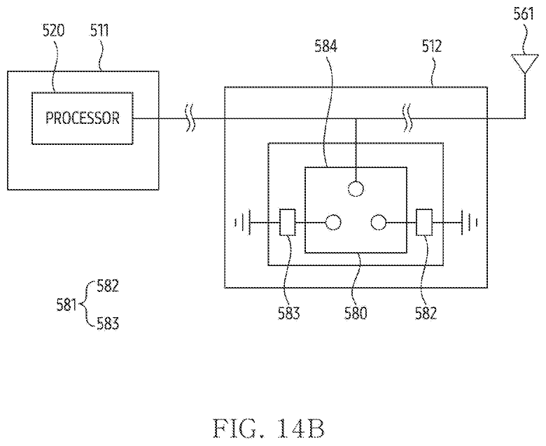

For example, the electronic device 101 may further include the antenna switching circuit 580 for changing an inductance of an inductor electrically connected to the antenna 561 or a capacitance of a capacitor. An operation in which the at least one processor 520 controls the antenna switching circuit 580 will be described later with reference to FIG. 14A.

As described above, the difference between the electrical characteristic of the first signal 811 and the electrical characteristic of the second signal 812 may occur according to the angle at which the portion (e.g., a portion 513c of FIG. 6A) of the third substrate 513 is bent. For example, since the first coupling signal 811c is the coupling signal for the first signal 811 from the RF transceiver 530, it may indicate an electrical characteristic of the transmission signal before passing through the third substrate 513. For example, since the second coupling signal 812c is the coupling signal for the second signal 812 from the third substrate 513, it may indicate an electrical characteristic of the transmission signal after passing through the third substrate 513. The at least one processor 520 may perform a deviation compensation control or another similar process to compensate for differences between the electrical characteristic of the first signal 811 and the electrical characteristic of the second signal 812 exceeding a reference value based on the first coupling signal 811c and the second coupling signal 812c. Through the deviation compensation control or the another similar process, the difference between the electrical characteristic of the first signal 811 and the electrical characteristic of the second signal 812 may be reduced. Through reduction of the difference, the at least one processor 520 may reduce deterioration of the communication performance of the electronic device 101.

Hereinafter, an operation of the at least one processor 520 will be described.

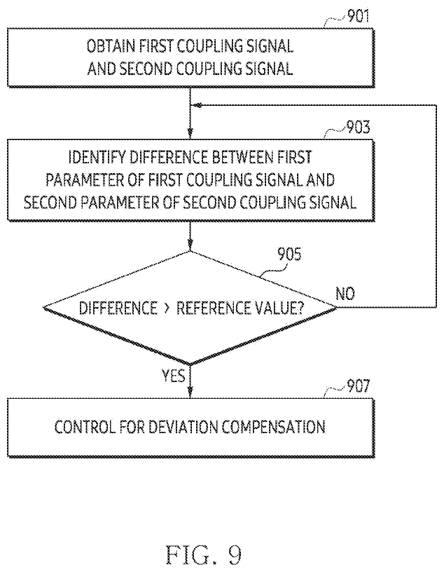

FIG. 9 is a flow chart indicating an operation of an exemplary electronic device.

Referring to FIG. 9, in operation 901, at least one processor (e.g., at least one processor 520 of FIG. 8A) may obtain a first coupling signal (e.g., a first coupling signal 811c of FIG. 8A) and a second coupling signal (e.g., a second coupling signal 812c of FIG. 8A).

For example, the at least one processor 520 may obtain the first coupling signal 811c from a first coupler (e.g., a first coupler 540 of FIG. 8A) disposed on a first substrate (e.g., a first substrate 511 of FIG. 8A). For example, the at least one processor 520 may obtain the first coupling signal 811c from a second coupler (e.g., a second coupler 550 of FIG. 8A) disposed on a second substrate (e.g., a second substrate 512 of FIG. 8A). The second coupling signal 812c may be provided to the first substrate 511 through a third substrate (e.g., a third substrate 513 of FIG. 8A). For example, the at least one processor 520 may receive the first coupling signal 811c and the second coupling signal 812c from an RF transceiver (e.g., an RF transceiver 530 of FIG. 8A). For example, the at least one processor 520 may control a switching circuit (e.g., a switching circuit 570 of FIG. 8A) so that the RF transceiver 530 is electrically connected to the first coupler 540. For example, the at least one processor 520 may control the switching circuit 570 so that the RF transceiver 530 is electrically connected to the second coupler 550. The RF transceiver 530 may receive the first coupling signal 811c and the second coupling signal 812c at different time. The RF transceiver 530 may down-convert the first coupling signal 811c and the second coupling signal 812c and may convert it into a digital signal. The at least one processor 520 may receive the converted first coupling signal 811c and the second coupling signal 812c from the RF transceiver 530.

In operation 903, the at least one processor 520 may identify a difference between a first parameter indicating an electrical characteristic of the first coupling signal 811c and a second parameter indicating an electrical characteristic of the second coupling signal 812c.

For example, the at least one processor 520 may obtain the first parameter of the first coupling signal 811c. For example, the at least one processor 520 may obtain the second parameter of the second coupling signal 812c. The at least one processor 520 may calculate a difference between the first parameter and the second parameter. For example, a parameter indicating the electrical characteristic may include at least one of power of the first coupling signal 811c and the second coupling signal 812c, a signal to noise ratio (SNR), or a voltage standing wave ratio (VSWR). However, the above-described parameters are merely exemplified as a parameter for identifying a disadvantage (e.g., a loss) caused by the third substrate 513, and this exemplary description is not to be interpreted as limiting a use of other parameters.

In operation 905, the at least one processor 520 may identify whether the difference between the first parameter and the second parameter exceeds a reference value. For example, the reference value may be set based on a degree to which the difference between the first parameter and the second parameter affects communication performance of an electronic device (e.g., an electronic device 101 of FIG. 8A). For example, when a transmission signal is provided to an antenna (e.g., an antenna 561 of FIG. 8A) through the first substrate 511, the third substrate 513, and the second substrate 512, a loss due to an impedance of an RF signal line (e.g., an RF signal line 805 of FIG. 8A) of the third substrate 513 may occur. Due to the loss, in case quality of a signal radiated through the antenna 561 is deteriorated, the communication performance of the electronic device 101 may be deteriorated. The reference value may be set based on a degree to which the deterioration of the quality of the signal affects the communication performance of the electronic device 101. For example, a difference between the first parameter and the second parameter less than or equal to the reference value may be an acceptable difference because the influence on the communication performance of the electronic device 101 is slight. For example, a difference between the first and second parameters exceeding the reference value may be an unacceptable difference because it causes the deterioration of the communication performance of the electronic device 101.

In case the difference exceeds the reference value, the at least one processor 520 may perform operation 907. In case the difference does not exceed the reference value, the at least one processor 520 may perform operation 901 again.

In operation 907, the at least one processor 520 may perform control for deviation compensation. For example, the at least one processor 520 may change transmission power outputted through the RF transceiver 530, based on the first coupling signal 811c provided from the first coupler 540 and the second coupling signal 812c provided from the second coupler 550.

For example, based on the first coupling signal 811c and the second coupling signal 812c, the at least one processor 520 may perform control to compensate for a difference (deviation) between the first parameter and the second parameter greater than or equal to the reference value. As described above, according to an angle at which the portion (e.g., a portion 513c of FIG. 6A) of the third substrate 513 is bent, a difference between an electrical characteristic of a first signal (e.g., a first signal 811 of FIG. 8A) and an electrical characteristic of a second signal (e.g., a second signal 812 of FIG. 8A) may occur. For example, the at least one processor 520 may perform control to compensate for the deviation so that the difference between the first parameter and the second parameter is less than or equal to the reference value. When the difference between the first parameter and the second parameter is less than or equal to the reference value, the difference between the electrical characteristic of the first signal 811 and the electrical characteristic of the second signal 812 is reduced, thereby reducing the deterioration of the communication performance of the electronic device 101. According to an embodiment, the electronic device 101 may maintain targeted communication performance regardless of a state (e.g., a first state, a second state, and a plurality of intermediate states) of the electronic device 101.

For example, the control for compensation for the deviation may include at least one of an operation of changing the transmission power outputted through the RF transceiver 530, an operation of changing an operating frequency of a signal to be transmitted through the antenna 561, an operation of changing an impedance of a signal line by changing an inductance of an inductor or a capacitance of a capacitor that are electrically connected to the antenna 561, and an operation of changing an antenna to be used for communication with an external electronic device from the antenna 561 to the other antenna 562.

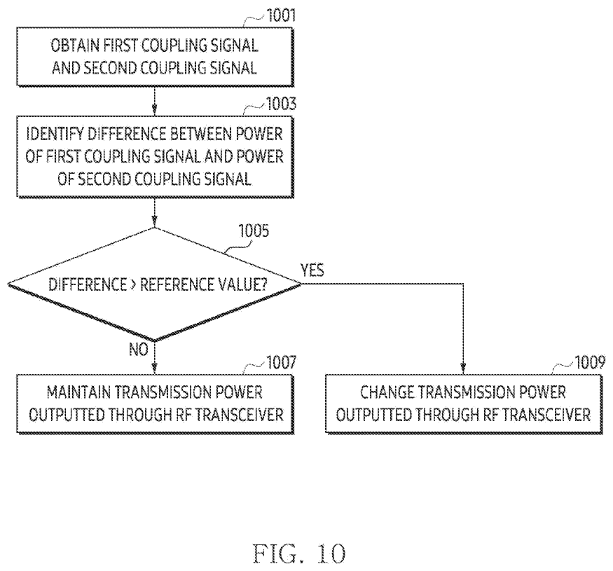

FIG. 10 is a flow chart indicating an example of an operation of changing transmission power based on power.

For example, a first parameter may be power of a first coupling signal (e.g., a first coupling signal 811c of FIG. 8A), and a second parameter may be power of a second coupling signal (e.g., a second coupling signal 812c of FIG. 8A). The power of the coupling signal may be proportional to transmission power outputted through an RF transceiver (e.g., an RF transceiver 530 in FIG. 8A). For example, when the transmission power outputted through the RF transceiver 530 increases, the power of the coupling signal may increase. For example, when the transmission power outputted through the RF transceiver 530 decreases, the power of the coupling signal may decrease.

Referring to FIG. 10, in operation 1001, at least one processor (e.g., at least one processor 520 of FIG. 8A) may obtain the first coupling signal 811c and the second coupling signal 812c. Operation 1001 in FIG. 10 may be substantially the same as operation 901 in FIG. 9.

In operation 1003, the at least one processor 520 may identify a difference between the power of the first coupling signal 811c and the power of the second coupling signal 812c.

For example, as illustrated in FIG. 6B, when an electronic device (e.g., an electronic device 101 of FIG. 8A) is in a second state, a portion (e.g., a portion 513c of FIG. 6A) of a third substrate (e.g., a third substrate 513 of FIG. 8A) may be flat. Since the portion 513c of the third substrate 513 including an RF signal line (e.g., an RF signal line 805 of FIG. 8A) is flat, a loss of an RF signal passing through the RF signal line 805 of the third substrate 513 may be relatively small. For example, as illustrated in FIG. 6A, when the electronic device 101 is in the first state, the portion 513c of the third substrate 513 may be bent. Since the portion 513c of the third substrate 513 including the RF signal line 805 is bent, a loss of a transmission signal passing through the RF signal line of the third substrate 513 may be relatively large. As the loss of the transmission signal changes, a loss of a first signal (e.g., a first signal 811 of FIG. 8A) that is a signal before passing through the third substrate 513 may be less than a loss of a second signal (e.g., a second signal 812 of FIG. 8A) that is a signal after passing through the third substrate 513. Due to a difference in the loss, the difference between the power of the first coupling signal 811c and the power of the second coupling signal 812c may occur. For example, when passing through the third substrate 513, in case the loss of the transmission signal is large, power of the transmission signal may be reduced. As the power of the transmission signal decreases, quality of a radiation signal transmitted through the antenna 561 may decrease.

For example, the at least one processor 520 may obtain the power of the first coupling signal 811c. For example, the at least one processor 520 may obtain the power of the second coupling signal 812c. For example, the at least one processor 520 may calculate the difference between the power of the first coupling signal 811c and the power of the second coupling signal 812c.

In operation 1005, the at least one processor 520 may identify whether the difference between the power of the first coupling signal 811c and the power of the second coupling signal 812c exceeds a reference value. For example, the reference value may be set to a value that may be determined that communication performance of the electronic device 101 has deteriorated due to the loss of the transmission signal. For example, the reference value may be about 2 dB to about 3 dB, but is not limited thereto.

In case the difference does not exceed the reference value, the at least one processor 520 may perform operation 1007. In case the difference exceeds the reference value, the at least one processor 520 may perform operation 1009.

In operation 1007, the at least one processor 520 may maintain the transmission power outputted through the RF transceiver 530. When the RF signal passes through the third substrate 513, since the loss of the transmission signal is small, a difference between power of a first signal 811 and power of a second signal 812 may be small. In case the difference between the power of the first signal 811 and the power of the second signal 812 is small, the difference between the power of the first coupling signal 811c and the power of the second coupling signal 812c may be less than or equal to the reference value. Since the loss of the RF signal is small, the electronic device 101 may have targeted communication performance. Since the electronic device 101 has the targeted communication performance, the at least one processor 520 may maintain the transmission power outputted through the RF transceiver 530 without changing it.

In operation 1009, the at least one processor 520 may change the transmission power outputted through the RF transceiver 530.

For example, when the RF signal passes through the third substrate 513, when the loss of the transmission signal is large, the difference between the power of the first signal 811 and the power of the second signal 812 may be large. For example, in the first state, since an angle at which the portion 513c of the third substrate 513 is bent is relatively large, the loss of the RF signal may be large. When the second signal 812 from the third substrate 513 is radiated through the antenna 561, the communication performance of the electronic device 101 may deteriorate. The at least one processor 520 may increase the transmission power outputted through the RF transceiver 530 in order to increase the power of the second signal 812. For example, based on identifying the difference between the power of the first coupling signal 811c and the power of the second coupling signal 812c exceeding the reference value, the at least one processor 520 may control the RF transceiver 530 to output the signal at the first transmission power higher than the second transmission power to be described later. The first transmission power may be referred to as power capable of compensating for the difference between the power of the first coupling signal 811c and the power of the second coupling signal 812c. For example, through a least square error estimation process for the difference between the power of the first coupling signal 811c and the power of the second coupling signal 812c, the first transmission power, which is compensation power, may be determined. As the transmission power increases, the loss generated while passing through the third substrate 513 is compensated, so that the difference between the power of the first signal 811 and the power of the second signal 812 may be reduced. For example, when the electronic device 101 is in the second state, since the portion 513c of the third substrate 513 is flat, a loss due to an impedance may be small. In the second state, the difference between the power of the first signal 811 and the power of the second signal 812 may be small. In case the difference between the power of the first signal 811 and the power of the second signal 812 is small, the difference between the power of the first coupling signal 811c and the power of the second coupling signal 812c may also be small. The at least one processor 520 may maintain the transmission power in response to identifying the difference between the power of the first coupling signal 811c and the power of the second coupling signal 812c equal to or less than the reference value.

For example, as the electronic device 101 changes from the second state to the first state (or an intermediate state), the portion 513c of the third substrate 513 may be bent. As the portion 513c is bent, the loss due to the impedance may be increased. In the first state (or the intermediate state), the difference between the power of the first signal 811 and the power of the second signal 812 may be large. In case the difference between the power of the first signal 811 and the power of the second signal 812 is large, the difference between the power of the first coupling signal 811c and the power of the second coupling signal 812c may also be large. The at least one processor 520 may increase the transmission power in response to identifying a difference between the power of the first coupling signal 811c and the power of the second coupling signal 812c exceeding the reference value. As the transmission power increases, the loss may be compensated. The power of the second signal 812 after increasing the transmission power may be greater than the power of the second signal 812 before increasing the transmission power.

For example, while the RF transceiver 530 outputs the signal with the first transmission power, the at least one processor 520 may perform the operation 1001, the operation 1003, and the operation 1005 again. For example, when the electronic device 101 is in the first state, a state of the electronic device 101 may be changed from the first state to the second state after the transmission power is increased. In the second state, since the portion 513c of the third substrate 513 may become flat, the loss of the transmission signal may be reduced. As the loss of the RF signal is reduced, the difference between the power of the first signal 811 and the power of the second signal 812 may be reduced. The at least one processor 520 may change the transmission power to the second transmission power lower than the first transmission power based on identifying the difference between the power of the first coupling signal 811c and the power of the second coupling signal 812c and identifying that the difference does not exceed the reference value. As the loss of the transmission signal is reduced, when the difference between the power of the first signal 811 and the power of the second signal 812 is less than the reference value, when the RF transceiver 530 outputs the signal with high power, unnecessary power consumption may be caused. The at least one processor 520 may reduce the unnecessary power consumption by again reducing the power outputted through the RF transceiver 530.

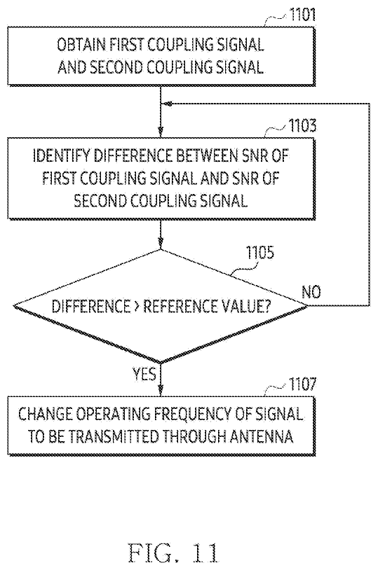

FIG. 11 is a flow chart indicating an example of an operation of changing an operating frequency of an antenna based on an SNR.

For example, a first parameter may be an SNR of a first coupling signal (e.g., a first coupling signal 811c of FIG. 8A), and a second parameter may be an SNR of a second coupling signal (e.g., a second coupling signal 812c of FIG. 8A). The SNR quantitatively indicates the influence of noise on an RF signal. For example, the SNR may be calculated based on [Equation 1] below.

$$SNR = \frac{{P}_{s i g}}{{P}_{n o i s e}} \qquad [ Equation 1 ]$$

P_{sig} indicates power of transmission signal. Pₙₒᵢₛₑ indicates noise power.

Referring to FIG. 11, in operation 1101, at least one processor (e.g., at least one processor 520 of FIG. 8A) may obtain the first coupling signal 811c and the second coupling signal 812c. Operation 1101 in FIG. 11 may be substantially the same as operation 901 in FIG. 9.

In operation 1103, the at least one processor 520 may identify a difference between the SNR of the first coupling signal 811c and the SNR of the second coupling signal 812c.

The SNR of the first coupling signal 811c may indicate the SNR of the first coupling signal 811c, which is an output signal of the first coupler 540 compared to the transmission signal outputted through an RF transceiver (e.g., an RF transceiver 530 of FIG. 8A). The SNR of the second coupling signal 812c may indicate the SNR of the second coupling signal 812c, which is an output signal of the second coupler 550 compared to the transmission signal outputted through the RF transceiver 530. For example, since positions of a first signal 811 and a second signal 812 are different in a housing (e.g., a housing 201 of FIG. 5A), the difference between the SNR of the first coupling signal 811c and the SNR of the second coupling signal 812c may occur. For example, according to a state of an electronic device (e.g., an electronic device 101 of FIG. 8A), the difference between the SNR of the first coupling signal 811c and the SNR of the second coupling signal 812c may occur.

For example, the difference between the SNR of the first coupling signal 811c and/or the SNR of the second coupling signal 812c may increase due to noise that may be induced from a first substrate (e.g., a first substrate 511 of FIG. 8A), a second substrate (e.g., a second substrate 512 of FIG. 8A), and/or a third substrate (e.g., a third substrate 513 of FIG. 8A), and/or noise that may be induced from a motor (e.g., a motor 361 of FIG. 5A) for driving an operation of the housing 201. In a first state, a second state, or a plurality of intermediate states, the SNR of the second coupling signal 812c may be reduced compared to the SNR of the first coupling signal 811c. For example, the at least one processor 520 may obtain the SNR of the first coupling signal 811c. For example, the at least one processor 520 may obtain the SNR of the second coupling signal 812c. For example, the at least one processor 520 may calculate the difference between the SNR of the first coupling signal 811c and the SNR of the second coupling signal 812c.

In operation 1105, the at least one processor 520 may identify whether the difference between the SNR of the first coupling signal 811c and the SNR of the second coupling signal 812c exceeds a reference value. For example, the reference value may be set to a value that may be determined that communication performance of the electronic device 101 has deteriorated due to the difference.

In case the difference exceeds the reference value, the at least one processor 520 may perform operation 1107. In case the difference does not exceed the reference value, the at least one processor 520 may perform operation 1101 again.

In operation 1107, the at least one processor 520 may change an operating frequency of a signal to be transmitted through the antenna (e.g., an antenna 561 of FIG. 8A).

For example, the difference between the SNR of the first coupling signal 811c and the SNR of the second coupling signal 812c may increase due to influence of noise in a specific frequency. The at least one processor 520 may change the operating frequency of the signal to be transmitted through the antenna 561 in order to compensate for the difference between the SNR of the first coupling signal 811c and the SNR of the second coupling signal 812c. The change of the operating frequency may be referred to as a transmission channel change. As the operating frequency is changed, noise according to the specific frequency may be reduced. Due to the reduction of the noise, the difference between the SNR of the first coupling signal 811c and the SNR of the second coupling signal 812c may be reduced.

Operation 1107 may be replaced with operation 1009 in FIG. 10. For example, based on identifying the difference between the SNR of the first coupling signal 811c and the SNR of the second coupling signal 812c exceeding the reference value, the at least one processor 520 may change transmission power outputted through the RF transceiver 530. For example, in case the SNR of the second coupling signal 812c is reduced compared to the SNR of the first coupling signal 811c, the at least one processor 520 may increase the transmission power outputted through the RF transceiver 530. Referring to [Equation 1] above, as the transmission power increases, the influence of noise on the signal is reduced, thereby reducing SNR. The difference between the SNR of the first coupling signal 811c and the SNR of the second coupling signal 812c may be reduced. As the difference between the SNR of the first coupling signal 811c and the SNR of the second coupling signal 812c is reduced, deterioration of the communication performance of the electronic device 101 may be reduced.

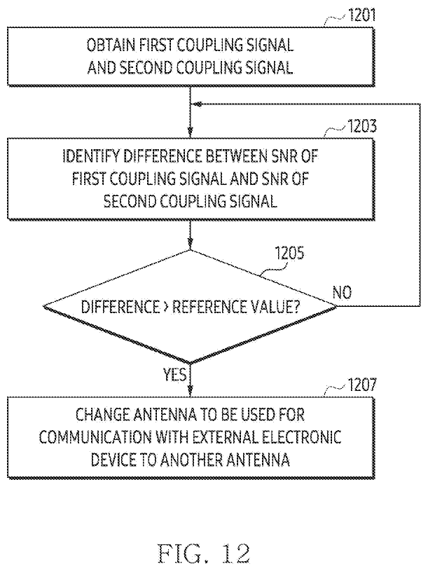

FIG. 12 is a flow chart indicating an example of an operation of changing an antenna based on an SNR.

Referring to FIG. 12, in operation 1201, at least one processor (e.g., at least one processor 520 of FIG. 8A) may obtain a first coupling signal (e.g., a first coupling signal 811c of FIG. 8A) and a second coupling signal (e.g., a second coupling signal 812c of FIG. 8A). Operation 1201 in FIG. 12 may be substantially the same as operation 901 in FIG. 9.

In operation 1203, the at least one processor 520 may identify a difference between an SNR of the first coupling signal 811c and an SNR of the second coupling signal 812c. Operation 1203 in FIG. 12 may be substantially the same as operation 1103 in FIG. 11.

In operation 1205, the at least one processor 520 may identify whether the difference between the SNR of the first coupling signal 811c and the SNR of the second coupling signal 812c exceeds a reference value. Operation 1205 in FIG. 12 may be substantially the same as operation 1105 in FIG. 11.

In case the difference exceeds the reference value, the at least one processor 520 may perform operation 1207. In case the difference does not exceed the reference value, the at least one processor 520 may perform operation 1201 again.

In operation 1207, the at least one processor 520 may change an antenna to be used for communication with an external electronic device to another antenna (e.g., another antenna 562 of FIG. 8A).

Referring again to FIG. 8A, an electronic device 101 may further include the other antenna 562. The other antenna 562 may be electrically connected to a first substrate 511. In FIG. 8A, the other antenna 562 is illustrated as being electrically connected to a first coupler 540, but is not limited thereto. For example, the other antenna 562 may not be electrically connected to the first coupler 540. For example, in case the other antenna 562 is electrically connected to the first coupler 540, a frequency band of a signal transmitted and/or received through the other antenna 562 may be the same as a frequency band of a signal transmitted and/or received through an antenna 561. However, it is not limited thereto. For example, in case the other antenna 562 is electrically connected to the first coupler 540, the frequency band of the signal transmitted and/or received through the other antenna 562 may be different from the frequency band of the signal transmitted and/or received through the antenna 561.

For example, the other antenna 562 may be disposed in a first housing part 210, but is not limited thereto. For example, when transmitting a transmission signal through the antenna 561 electrically connected to a second substrate 512, the SNR may be reduced due to the influence of noise while the transmission signal passes through a third substrate 513. The at least one processor 520 may change the antenna to be used for communication with the external electronic device to the other antenna 562 so that a signal to be transmitted to the external electronic device does not pass through the third substrate 513. Since the other antenna 562 is electrically connected to the first substrate 511, the signal may not pass through the third substrate 513. For example, since a processor and an RF transceiver 530 are disposed on the first substrate 511, they may be electrically connected to the other antenna 562 electrically connected to the first substrate 511 through the first substrate 511. When the electronic device 101 transmits the signal to the external electronic device, the transmission signal may not pass through the third substrate 513 but may be radiated through the other antenna 562 electrically connected to the first substrate 511. As the signal does not pass through the third substrate 513, the influence of noise may be reduced. As the influence of noise on the signal to be transmitted is reduced, communication performance of the electronic device 101 may be improved.

FIG. 13A is a schematic block diagram of an exemplary electronic device. FIG. 13B illustrates an exemplary dual directional coupler. FIG. 13C illustrates an exemplary third substrate. FIG. 13D is a cross-sectional view of an exemplary third substrate cut along C-C′ of FIG. 13C.

An electronic device 101 illustrated in FIG. 13A may be substantially the same as the electronic device 101 illustrated in FIG. 8A except for a description described with reference to FIGS. 13A, 13B, 13C, and 13D. Hereinafter, the same reference numerals may be assigned to the same components. A redundant description may be omitted.

Referring to FIGS. 13A and 13B, a first coupler 540 and a second coupler 550 may be a dual directional coupler. The dual directional coupler, as a directional coupler, may be inserted into a line between an RF source and a load. The dual directional coupler may provide RF power corresponding to a forward direction and power reflected from the load to the source. The dual directional coupler means an RF element for extracting a coupling signal (hereinafter referred to as a forward coupling signal) of a signal corresponding to a traveling direction of a transmission signal and a coupling signal (hereinafter referred to as a reverse coupling signal) of a reflection signal opposite to the traveling direction of the transmission signal. The dual directional coupler may be referred to as a dual coupler or a bidirectional coupler.

Referring to FIG. 13B, a dual directional coupler 1300 may include four ports. The four ports may include a first port 1301 for signal input, a second port 1302 for signal output, a third port 1303 for the forward coupling signal, and a fourth port 1304 for the reverse coupling signal. The dual directional coupler 1300 may include an RF line 805 for power transmission between the first port 1301 and the second port 1302. The first port 1301 may be referred to as an input port. The second port 1302 may be referred to as an output port. The dual directional coupler 1300 may include a first coupling signal line 1305 connected to the third port 1303 and adjacent to the RF line 805. The dual directional coupler 1300 may output the forward coupling signal to the third port 1303 through the first coupling signal line 1305. The dual directional coupler 1300 may include a second coupling signal line 1306 connected to the fourth port 1304 and adjacent to the RF line 805. Through the second coupling signal line 1306, the dual directional coupler 1300 may output the reverse coupling signal to the fourth port 1304. The third port 1303 may be referred to as the forward coupling port. The fourth port 1304 may be referred to as the reverse coupling port. A direction of the third port 1303 from a termination impedance of the first coupling signal line 1305 and a direction of the fourth port 1304 from a termination impedance of the second coupling signal line 1306 may be opposite to each other.

Referring to FIG. 13A, the first coupling signal line 1305 may include a first forward coupling signal line 1305a and a second forward coupling signal line 1305b. The second coupling signal line 1306 may include a first reverse coupling signal line 1306a and a second reverse coupling signal line 1306b. The first coupler 540 may provide a first forward coupling signal 811f, which is a signal component corresponding to the traveling direction of the transmission signal, and a first reverse coupling signal 811r, which is a signal component reflected from an RF signal line. For example, the first coupler 540 may output the first forward coupling signal 811f through the first forward coupling signal line 1305a. For example, the first coupler 540 may output the first reverse coupling signal 811r through the first reverse coupling signal line 1306a.

The second coupler 550 may provide a second forward coupling signal 812f, which is a signal component corresponding to the traveling direction of the RF signal, and a second reverse coupling signal 812r, which is a signal component reflected from the RF signal line. For example, the second coupler 550 may output the second forward coupling signal 812f through the second forward coupling signal line 1305b. For example, the second coupler 550 may output the second reverse coupling signal 812r through the second reverse coupling signal line 1306b.

For example, a switching circuit 570 may electrically connect an RF transceiver 530 and the first coupler 540. The switching circuit 570 may electrically connect the RF transceiver 530 and the second coupler 550. For example, the switching circuit 570 may be connected to the first forward coupling signal line 1305a, the first reverse coupling signal line 1306a, the second forward coupling signal line 1305b, the second reverse coupling signal line 1306b, and a third coupling signal line 804c between the RF transceiver 530 and the switching circuit 570.

For example, at least one processor 520 may receive the first forward coupling signal 811f by controlling the switching circuit 570 to electrically connect the first forward coupling signal line 1305a and the third coupling signal line 804c. For example, the at least one processor 520 may receive the first reverse coupling signal 811r by controlling the switching circuit 570 to electrically connect the second reverse coupling signal line 1306a and the third coupling signal line 804c. For example, the at least one processor 520 may receive the second forward coupling signal 812f by controlling the switching circuit 570 to electrically connect the second forward coupling signal line 1305b and the third coupling signal line 804c. For example, the at least one processor 520 may receive the second reverse coupling signal 812r by controlling the switching circuit 570 to electrically connect the second reverse coupling signal line 1306b and the third coupling signal line 804c.

The first forward coupling signal 811f and the first reverse coupling signal 811r provided through the first coupler 540, which is the dual directional coupler, may be used to calculate a voltage standing wave ratio (VSWR) of the first signal 811. The second forward coupling signal 812f and the second reverse coupling signal 812r provided through the second coupler 550, which is the dual directional coupler, may be used to calculate a voltage VSWR of a second signal 812. The VSWR may be calculated based on [Equation 2] below.

$$VSWR = \frac{1 + \vert Γ \vert}{1 - \vert Γ \vert} \qquad [ Equation 2 ]$$

Γ indicates a reflection coefficient. The reflection coefficient may be calculated based on [Equation 3] below.

$$Reflection coefficient = \frac{{s}_{fwd}}{{s}_{rev}} \qquad [ Equation 3 ]$$

Reflection coefficient indicates the reflection coefficient. S_{fwd} indicates the forward coupling signal. Sᵣₑᵥ indicates the reverse coupling signal.

Referring to the [Equation 2] and the [Equation 3], a first VSWR of the first signal 811 and a second VSWR of the second signal 812 may be calculated. For example, the reflection coefficient of the first signal 811 may be calculated based on the first forward coupling signal 811f, the first reverse coupling signal 811r, and the [Equation 3], and the first VSWR of the first signal 811 may be calculated based on the reflection coefficient and the [Equation 2]. For example, the reflection coefficient of the second signal 812 may be calculated based on the second forward coupling signal 812f, the second reverse coupling signal 812r, and the [Equation 3], and the second VSWR of the second signal 812 may be calculated based on the reflection coefficient and the [Equation 2].

For example, since the second coupler 550 is disposed on a second substrate 512, the second forward coupling signal line 1305b and the second reverse coupling signal line 1306b may pass from the second substrate 512 through a third substrate 513 and be connected to a switching circuit line disposed on a first substrate 511. The third substrate 513 may include the second forward coupling signal line 1305b and the second reverse coupling signal line 1306b.

Referring to FIG. 13C, the third substrate 513 may include a plurality of layers 5131, 5132, and 5133 laminated on each other. The third substrate 513 may transmit a signal through a signal line formed on each of the plurality of layers 5131, 5132, and 5133. For example, the third substrate 513 may include the first layer 5131, the second layer 5132, and/or the third layer 5133. However, it is not limited thereto.

Referring to FIG. 13D, the third substrate 513 may include an RF signal line 805 formed on the second layer 5132. The RF signal line 805 may be a signal line for transmitting the transmission signal and a reception signal.

For example, an antenna (e.g., an antenna 561 of FIG. 8A) electrically connected to a second substrate (e.g., the second substrate 512 of FIG. 8A) may be plural. For example, the antenna 561 may include a first antenna for transmitting and/or receiving a signal on a first frequency band (e.g., low band), a second antenna for transmitting and/or receiving a signal on a second frequency band (e.g., high band), and a third antenna for transmitting and/or receiving a signal on a third frequency band (e.g., ultra high band). However, it is not limited thereto. The RF signal line 805 formed in the second layer 5132 may include a first signal line M1 electrically connected to the first antenna, a second signal line M2 electrically connected to the second antenna, and/or a third signal line M3 connected to the third antenna.

For example, the second layer 5132 may include the second coupler 550 disposed on the second substrate 512 and the second forward coupling signal line 1305b and the second reverse coupling signal line 1306b electrically connected to the switching circuit 570 disposed on the first substrate 511. The second forward coupling signal line 1305b and the second reverse coupling signal line 1306b formed on the second layer 5132 may be spaced apart from each other to reduce the influence of mutual coupling. For example, at least one signal line may be disposed between the second forward coupling signal line 1305b and the second reverse coupling signal line 1306b. For example, the at least one signal line may include at least one of the first signal line M1, the second signal line M2, and/or the third signal line M3. However, it is not limited thereto. For example, the electronic device 101 may include a MIMO LNA Front-End Module (LFEM) for a multiple input multiple output (MIMO) antenna 561. The LEFM may include output signal lines L1, L2, L3, and L4 of four LEFMs to transmit and/or receive a reference signal (e.g., a sounding reference signal (SRS)) with a base station. The second layer 5132 may include the output signal lines L1, L2, L3, and L4 of the LEFM. For example, the electronic device 101 may perform an antenna switching operation according to 1-transmit 4-receive (1T4R) in a frequency band (e.g., a n41 band) defined in a standard of 3GPP. The second layer 5132 may include signal lines capable of outputting the SRS for the antenna 561 transmitting and/or receiving a signal of the frequency band. For example, the at least one signal line disposed between the second forward coupling signal line 1305b and the second reverse coupling signal line 1306b may further include at least one of the above-described signal lines L1, L2, L3, L4, and SRS.

FIG. 14A is a flow chart indicating an example of an operation of changing an impedance of a transmission signal based on a VSWR. FIG. 14B illustrates an exemplary antenna switching circuit.

Referring to FIG. 14A, in operation 1401, at least one processor (e.g., at least one processor 520 of FIG. 13A) may obtain a first coupling signal (e.g., a first coupling signal 811c of FIG. 13A) and a second coupling signal (e.g., a second coupling signal 812c of FIG. 13A). Operation 1401 in FIG. 14A may be substantially the same as operation 901 in FIG. 9.

In operation 1403, the at least one processor 520 may identify a difference between a VSWR of the first coupling signal 811c and a VSWR of the second coupling signal 812c.

For example, a first parameter may be a first VSWR of the first coupling signal 811c, and a second parameter may be a second VSWR of the second coupling signal 812c. The first VSWR may be calculated based on a first forward coupling signal 811f of a first signal (e.g., a first signal 811 of FIG. 13A) and a first reverse coupling signal 811r of the first signal. The second VSWR may be calculated based on a second forward coupling signal 812f of a second signal (e.g., a second signal 812 of FIG. 13A) and a second reverse coupling signal 812r of the second signal 812.

For example, when an electronic device 101 is in a first state, as a bent angle of the portion (e.g., a portion 513c of FIG. 6A) of a third substrate (e.g., a third substrate 513 of FIG. 13a) increases, an impedance of an RF signal line 805 of the third substrate 513 may increase. For example, while the second signal 812 passes through the RF signal line 805 of the third substrate 513, the VSWR may be increased by the impedance of the RF signal line 805 of the third substrate 513. For example, as a reflected signal increases due to the impedance of the RF signal line of the third substrate 513, the VSWR may increase. In order to lower the VSWR, impedance matching may be required.

In operation 1405, the at least one processor 520 may identify whether the difference between the VSWR of the first coupling signal 811c and the VSWR of the second coupling signal 812c exceeds a reference value. For example, the reference value may be set to a value that may be determined that communication performance of the electronic device 101 has deteriorated due to the difference.

In case the difference exceeds the reference value, the at least one processor 520 may perform operation 1407. In case the difference does not exceed the reference value, the at least one processor 520 may perform operation 1101 again.

In operation 1407, the at least one processor 520 may change an impedance of a signal outputted through an RF transceiver (e.g., an RF transceiver 530 of FIG. 13A).

For example, the at least one processor 520 may change the impedance of the signal by changing a parameter value (e.g., an inductance or a capacitance) of at least one passive element 581 electrically connected to an antenna (e.g., an antenna 561 of FIG. 13A) through an antenna switching circuit (e.g., an antenna switching circuit 580 of FIG. 13A). For example, the electronic device 101 may further include the antenna switching circuit 580.

Referring to FIG. 14B, the antenna switching circuit 580 may be configured to electrically connect the at least one passive element 581 and the antenna 561. For example, the at least one passive element 581 may include an inductor 582 and/or a capacitor 583 having a designated parameter value (e.g., the inductance or the capacitance), but is not limited thereto. For example, the at least one passive element 581 may include a variable inductor 582 and/or a variable capacitor 583 having a variable parameter value. For example, the antenna switching circuit 580 may include a switching circuit 584 electrically connecting the antenna 561 and the at least one passive element 581.

For example, the at least one processor 520 may control the antenna switching circuit 580 to reduce reflection due to impedance difference. For example, the at least one processor 520 may control the antenna switching circuit 580 to change the impedance of the signal outputted through the RF transceiver 530. For example, the at least one processor 520 may be configured to change an inductance of the inductor 582 or a capacitance of the capacitor 583 that is electrically connected to the antenna 561. For example, the at least one processor 520 may be configured to change the inductance of the inductor 582 or the capacitance of the capacitor 583 that is electrically connected to the antenna 561 by changing the inductor 582 or the capacitor 583 that is electrically connected to the antenna 561. For example, the at least one processor 520 may be configured to change an inductance of the variable inductor 582 or a capacitance of the variable capacitor 583 that is electrically connected to the antenna 561. As an impedance of a signal line of the transmission signal is matched, a difference between the first VSWR and the second VSWR may be reduced. However, it is not limited thereto. For example, the at least one processor 520 may change the impedance of the transmission signal outputted through the RF transceiver 530, based on identifying the difference between the first VSWR and the second VSWR exceeding the reference value. For example, the at least one processor 520 may change the impedance of the transmission signal by changing an inductance of an inductor at an output end of a power amplifier (e.g., a power amplifier 591 of FIG. 8A) and/or a capacitance value of a capacitor at the output end of the power amplifier 591.

An electronic device 101 is provided. The electronic device may comprise a housing 201, a memory (130), a first substrate 511, a second substrate 512, a third substrate 513, at least one processor 520, an RF transceiver 530, a first coupler 540, and a second coupler 550. For example, the housing 201 may include a first housing part 210 and a second housing part 220 movably coupled to each other. The memory (130) may store instructions. The first substrate 511 may be disposed on the second housing part 220. The second substrate 512 may be disposed on the first housing part 210. The third substrate 513 may be deformable based on a movement of the first housing part 210 or the second housing part 220. The third substrate 513 may electrically connect the first substrate 511 and the second substrate 512. The at least one processor 520 may be disposed on the first substrate 511. The radio frequency (RF) transceiver 530 may be disposed on the first substrate 511. The first coupler 540 may be disposed on the first substrate 511. The first coupler 540 may be configured to provide a first coupling signal 811c based on a first signal 811 from the RF transceiver 530. The second coupler 550 may be disposed on the second substrate 512. The second coupler 550 may be configured to provide a second coupling signal 812c based on a second signal 812 from the third substrate 513. For example, according to the movement of the first housing part or the second housing part, a shape of a portion of the third substrate between a first connector and a second connector may be deformed. Based on an angle at which the portion of the third substrate is bent, an impedance of an RF signal line formed in the third substrate may change. A loss of the RF signal may change due to a change in the impedance of the RF signal line. The electronic device may change the transmission power to compensate for a characteristic difference between the first signal, which is a signal before passing through the third substrate, and the second signal, which is a signal after passing through the third substrate. For example, the electronic device may identify the characteristic difference by using a coupling signal of the first signal (e.g., the first coupling signal) and a coupling signal of the second signal (e.g., the second coupling signal). As the characteristic difference is compensated, the electronic device may maintain targeted communication performance regardless of a state.

For example, the electronic device 101 may further comprise an antenna 561 electrically connected to the second coupler 550, through the second substrate 512. For example, the third substrate 513 may include a first connector 513a connected to the first substrate 511 and a second connector 513b connected to the second substrate 512. The third substrate 513 may be at least partially bent or unfolded based on the movement of the first housing part 210 or the second housing part 220.

For example, a portion 513c of the third substrate 513 between the first connector 513a and the second connector 513b may be bent in a first state in which a size of the housing 201 is minimum. The portion 513c of the third substrate 513 may be flat in a second state in which the size of the housing 201 is maximum. For example, as the first housing part or the second housing part moves, a relative positional relationship between the first substrate and the second substrate may change. The third substrate electrically connecting the first substrate and the second substrate may be deformed as the positional relationship changes. Through the deformable third substrate, an electrical connection between at least one electronic component (e.g., a processor) electrically connected to the first substrate and at least one electronic component (e.g., an antenna) electrically connected to the second substrate may be possible.

For example, the at least one processor 520 may be configured to set a transmission power outputted through the RF transceiver 530, based on the first coupling signal 811c provided from the first coupler 540 and the second coupling signal 812c provided from the second coupler 550.

For example, the first coupler 540 may be disposed between the RF transceiver 530 and the first connector 513a. The second coupler 550 may be disposed between the second connector 513b and the antenna 561. For example, the first coupler may be disposed between the RF transceiver and the first connector in order to provide the first coupling signal, which is the coupling signal of the first signal from the RF transceiver, to the RF transceiver. The second coupler may be disposed between the second connector and the antenna in order to provide the second coupling signal, which is the coupling signal of the second signal from the third substrate, to the RF transceiver.

For example, the at least one processor 520 may be configured to change a transmission power outputted through the RF transceiver 530, based on identifying that a difference between an electrical characteristic of the first coupling signal 811c and an electrical characteristic of the second coupling signal 812c exceeds a reference value. For example, when the RF signal passes through the third substrate, in case the loss of the RF signal is large, a difference between a power of the first signal and a power of the second signal may be large. The at least one processor may change the transmission power to compensate for the difference between the power of the first signal and the power of the second signal. For example, at least one processor may increase the power of the second signal provided to the antenna by increasing the transmission power. By the above operation, the difference between the power of the first signal and the power of the second signal is reduced, so that the electronic device may maintain the targeted communication performance regardless of a state of the electronic device.

For example, the at least one processor 520 may be configured to control the RF transceiver 530 to output a signal with a first transmission power, based on identifying that the difference between the electrical characteristic of the first coupling signal 811c and the electrical characteristic of the second coupling signal 812c exceeds a reference value. The at least one processor 520 may be configured to control the RF transceiver 530 to output the signal with a second transmission power lower than the first transmission power, while the RF transceiver 530 outputs the signal with the first transmission power, based on identifying that the difference between the electrical characteristic of the first coupling signal 811c and the electrical characteristic of the second coupling signal 812c, which are equal to or less than the reference value. For example, the electronic device may increase the transmission power to compensate for the difference between the power of the first signal and the power of the second signal. After increasing the transmission power, if the difference between the power of the first signal and the power of the second signal decreases as the state of the electronic device changes, the electronic device may reduce unnecessary power consumption by lowering the transmission power.

For example, the electrical characteristic may comprise at least one of power of the first coupling signal 811c and the second coupling signal 812c, a signal to noise ratio (SNR) of the first coupling signal 811c and the second coupling signal 812c, or a voltage standing wave ratio (VSWR) of the first coupling signal 811c and the second coupling signal 812c. For example, from a difference in an electrical characteristic indicating an electrical characteristic of the first signal and an electrical characteristic of the second signal, a disadvantage (e.g., the loss) of a transmission signal due to the third substrate may be identified.

The at least one processor 520 may be configured to change an operating frequency of a signal to be transmitted through the antenna 561, based on identifying that a difference between the electrical characteristic of the first coupling signal 811c and the electrical characteristic of the second coupling signal 812c exceeds a reference value. For example, a difference between the SNR of the first signal and the SNR of the second signal may be increased due to influence of noise within a specific frequency. The at least one processor may compensate for the difference between the SNR of the first signal and the SNR of the second signal by changing the operating frequency of the signal to be transmitted through the antenna.

For example, the electronic device 101 may further comprise an antenna switching circuit 580 including at least one of an inductor 582 or a capacitor 583, electrically connected to the antenna 561. The at least one processor 520 may be configured to change an inductance of the inductor 582 or a capacitance of the capacitor 583, electrically connected to the antenna 561, based on identifying that the difference between the electrical characteristic of the first coupling signal 811c and the electrical characteristic of the second coupling signal 812c, exceeds the reference value. For example, the at least one processor may change an impedance of the transmission signal by changing an electrical characteristic value (e.g., the inductance or the capacitance) of at least one passive element electrically connected to the antenna through the antenna switching circuit. For example, the at least one processor may tune the operating frequency of the antenna by changing the electrical characteristic value (e.g., the inductance or the capacitance) of the at least one passive element electrically connected to the antenna through the antenna switching circuit. Changing the impedance of the transmission signal and/or changing the operating frequency of the antenna may reduce a difference between the electrical characteristic of the first signal and the electrical characteristic of the second signal. As the difference is reduced, communication performance of the electronic device may be improved.

For example, the electronic device 101 may further comprise another antenna 562 electrically connected the first substrate 511. The at least one processor 520 may be configured to change an antenna to be used for communication with an external electronic device from the antenna 561 to the other antenna 562, based on identifying that a difference between the electrical characteristic of the first coupling signal 811c and the electrical characteristic of the second coupling signal 812c, exceeds the reference value. For example, when transmitting a signal through an antenna electrically connected to the second substrate, the SNR may be reduced due to the influence of noise while the signal passes through the third substrate. The at least one processor may change an antenna to be used for communication with the external electronic device to the other antenna so that a signal to be transmitted to the external electronic device does not pass through the third substrate. As the signal does not pass through the third substrate, the influence of noise may be reduced. As the influence of noise on the signal to be transmitted is reduced, the communication performance of the electronic device may be improved.

For example, the at least one processor 520 may be configured to receive a forward coupling signal of the first signal 811 and a reverse coupling signal of the first signal 811, provided from the first coupler 540, and a forward coupling signal of the second signal 812 and a reverse coupling signal of the second signal 812, provided from the second coupler 550. The at least one processor 520 may be configured to change an impedance of a signal outputted through the RF transceiver 530, based on identifying that a difference between a first VSWR, based on the forward coupling signal of the first signal 811 and the reverse coupling signal of the first signal 811, and a second VSWR, based on the forward coupling signal of the second signal 812 and the reverse coupling signal of the second signal 812, exceeds a reference value. For example, the electronic device may identify the disadvantage (e.g., the loss) of the signal due to the third substrate through the VSWR. For the above identification, the electronic device may include the first coupler and the second coupler, which are dual directional couplers. The at least one processor may identify the disadvantage (e.g., the loss) of the signal due to the third substrate by identifying the difference between the first VSWR and the second VSWR. The at least one processor may reduce the difference between the first VSWR and the second VSWR by changing the impedance of the transmission signal. As the difference between the first VSWR and the second VSWR is reduced, the communication performance of the electronic device may be improved.

For example, the third substrate 513 may comprise a forward coupling signal line 1306a, a reverse coupling signal line 1306b, and at least one signal line. The forward coupling signal line 1306a may be configured to transmit a forward coupling signal of the second signal 812. The reverse coupling signal line 1306b may be configured to transmit a reverse coupling signal of the second signal 812. The at least one signal line may be disposed between the forward coupling signal line and the reverse coupling signal line. For example, the third substrate may include a signal line for the forward coupling signal of the second signal and a signal line for the reverse coupling signal of the second signal. In order to reduce coupling between the signal lines, the third substrate may include the at least one signal line disposed in the signal line for the forward coupling signal of the second signal and the signal line for the reverse coupling signal of the second signal. By the above structure, mutual interference between the forward coupling signal of the second signal and the reverse coupling signal of the second signal may be reduced. As the interference is reduced, the at least one processor may accurately calculate the second VSWR.

For example, the second substrate 512 may be disposed on one surface 210a of the first housing part 210. The second coupler 550 may include a conductive pattern embedded in the second substrate 512. For example, since the second substrate may be disposed on one surface of the first housing part, a thickness of the second coupler may be limited. In order to reduce the thickness of the second coupler, the second coupler may include the conductive pattern embedded in the second substrate. As the second coupler is not disposed on the second substrate as a separate component but is implemented as the conductive pattern embedded in the second substrate, the thickness of the second coupler may be reduced.

For example, the electronic device 101 may further comprise a switching circuit 570. The switching circuit 570 may be disposed on the first substrate 511 and may be configured to electrically connect the first coupler 540 or the second coupler 550 to the RF transceiver 530. The at least one processor may be configured to obtain the first coupling signal 811c, based on electrically connecting the at least one processor 520 and the first coupler 540 through the switching circuit 570. The at least one processor may be configured to obtain the second coupling signal 812c, based on electrically connecting the at least one processor 520 and the second coupler 550 through the switching circuit 570. For example, the first coupling signal and the second coupling signal may be provided to the at least one processor at different time. At least one processor may control the switching circuit so that the first coupling signal and the second coupling signal are provided at different time.

For example, the electronic device 101 may comprise a display 230. The display 230 may include a first display area 230a and a second display area 230b. The second display area 230b is at least partially bendable into the first housing part 210 based on the movement of the first housing part 210 or the second housing part 220. The at least a portion of the second display area 230b may be rolled into the first housing part 210 in a first state. The at least a portion of the second display area 230b may be drawn from the inside of the first housing part 210 to an outside of the first housing part 210 in a second state. For example, a size of a display area of a display may be changed. In order to change the size of the display area of the display, at least a portion of the second display area may be rolled into the first housing part in the first state. Since a size of the housing and the size of the display area of the display may be changed, the electronic device may provide various user experiences.

An electronic device 101 is provided. The electronic device 101 may comprise a first substrate 511, a second substrate 512, a third substrate 513, at least one processor 520, an RF transceiver 530, a first coupler 540, a second coupler 550, and an antenna 561. The second substrate 512 may be space apart from the first substrate 511. The third substrate 513 may electrically connect the first substrate 511 and the second substrate 512. The third substrate 513 may include a first connector 513a connected to the first substrate 511 and a second connector 513b connected to the second substrate 512. The at least one processor 520 may be disposed on the first substrate 511. The RF transceiver 530 may be disposed on the first substrate 511. The first coupler 540 may be disposed on the first substrate 511. The first coupler 540 may be configured to provide a first coupling signal 811c based on the first signal 811 from the RF transceiver 530. The second coupler 550 may be disposed on the second substrate 512. The second coupler 550 may be configured to provide a second coupling signal 812c based on the second signal 812 from the third substrate 513. The antenna 561 may be electrically connected to the second coupler 550 through the second substrate 512. The at least one processor 520 may be configured to identify a difference between an electrical characteristic of the first coupling signal 811c provided from the first coupler 540 and the electrical characteristic of the second coupling signal 812c provided from the second coupler 550. The at least one processor 520 may be configured to change a transmission power outputted through the RF transceiver 530, based on identifying that the difference between the electrical characteristic of the first coupling signal 811c and the electrical characteristic of the second coupling signal 812c exceeds a reference value.

For example, the first coupler 540 may be disposed between the RF transceiver 530 and the first connector 513a. The second coupler 550 may be disposed between the second connector 513b and the antenna 561.

For example, the electrical characteristic may include at least one of power of the first coupling signal 811c and the second coupling signal 812c, a signal to noise ratio (SNR) of the first coupling signal 811c and the second coupling signal 812c, and/or a voltage standing wave ratio (VSWR) of the first coupling signal 811c and the second coupling signal 812c.

For example, the at least one processor 520 may be configured to change an operating frequency of a signal to be transmitted through the antenna 561, based on identifying that the difference between the electrical characteristic of the first coupling signal 811c and the electrical characteristic of the second coupling signal 812c exceeds the reference value.

For example, the electronic device 101 may further comprise another antenna 562 electrically connected to the first substrate 511. The at least one processor 520 may be configured to change an antenna to be used for communication with an external electronic device from the antenna 561 to the other antenna 562, based on identifying that a difference between the electrical characteristic of the first coupling signal 811c and the electrical characteristic of the second coupling signal 812c exceeds a reference value.

An electronic device comprises: first and second housing parts movably coupled to each other; first and second substrates disposed on the first and second housing parts, respectively; a third substrate deformable based on movement of the first housing part or the second housing part and electrically connecting the first and second substrates; a radio frequency (RF) transceiver; a first coupler disposed on the first substrate and configured to provide a first coupling signal based on a first signal from the RF transceiver; and a second coupler disposed on the second substrate and configured to provide a second coupling signal based on a second signal from the third substrate.

A method of operating an electronic device comprising first and second housing parts movably coupled to each other, first and second substrates disposed on the first and second housing parts, respectively, a third substrate deformable based on first or second housing part movement and electrically connecting the first and second substrates and a transceiver, the method comprises: obtaining a first coupling signal from a first coupler disposed on the first substrate based on a transceiver signal; obtaining a second coupling signal from a second coupler disposed on the second substrate based on a third substrate signal; identifying a first difference between respective parameters of the first and second coupling signals; determining whether the first difference exceeds a reference value; and controlling for deviation compensation in an event the first difference exceeds the reference value.

The method further comprises: identifying a second difference between respective powers of the first and second coupling signals; determining whether the second difference exceeds a reference value; maintaining power transmission output through the transceiver in an event the second difference does not exceed the reference value; and changing the power transmission output through the transceiver in an event the second difference exceeds the reference value.

The method further comprises: identifying a third difference between respective signal to noise ratios (SNRs) of the first and second coupling signals; determining whether the third difference exceeds a reference value; and changing an operating frequency of a signal transmitted through an antenna in an event the third difference exceeds the reference value.

The method further comprises: identifying a fourth difference between respective signal to noise ratios (SNRs) of the first and second coupling signals; determining whether the fourth difference exceeds a reference value; and changing an antenna for signal transmission in an event the fourth difference exceeds the reference value.

The method further comprises: identifying a fifth difference between respective voltage standing wave ratios (VSWRs).of the first and second coupling signals; determining whether the fifth difference exceeds a reference value; and changing an impedance of a transmission signal in an event the fifth difference exceeds the reference value.

The method further comprises: identifying a second difference between respective powers of the first and second coupling signals, a third difference between respective signal to noise ratios (SNRs) of the first and second coupling signals, a fourth difference between respective signal to noise ratios (SNRs) of the first and second coupling signals and a fifth difference between respective voltage standing wave ratios (VSWRs).of the first and second coupling signals; determining whether any of the second, third, fourth or fifth differences exceeds a corresponding reference value; and one of: maintaining power transmission output through the transceiver in an event the second difference does not exceed the reference value and changing the power transmission output through the transceiver in an event the second difference exceeds the reference value; changing an operating frequency of a signal transmitted through an antenna in an event the third difference exceeds the reference value; changing an antenna for signal transmission in an event the fourth difference exceeds the reference value; and changing an impedance of a transmission signal in an event the fifth difference exceeds the reference value.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the clement may be coupled with the other clement directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a housing including a first housing part and a second housing part movably coupled to each other;
a memory storing instructions;
a first substrate disposed on the second housing part;
a second substrate disposed on the first housing part;
a third substrate deformable based on a movement of the first housing part or the second housing part and electrically connecting the first substrate and the second substrate;
at least one processor disposed on the first substrate;
a radio frequency (RF) transceiver disposed on the first substrate;
a first coupler disposed on the first substrate and configured to provide a first coupling signal based on a first signal from the RF transceiver; and
a second coupler disposed on the second substrate and configured to provide a second coupling signal based on a second signal from the third substrate.

2. The electronic device of claim 1, further comprising an antenna electrically connected to the second coupler through the second substrate,
wherein the third substrate includes a first connector connected to the first substrate and a second connector connected to the second substrate and is at least partially bent based on the movement of the first housing part or the second housing part.

3. The electronic device of claim 2,
wherein first coupler is disposed between the RF transceiver and the first connector, and
wherein the second coupler is disposed between the second connector and the antenna.

4. The electronic device of claim 1,
wherein the instructions, when executed by the at least one processor, cause the electronic device to set a transmission power outputted through the RF transceiver based on the first coupling signal provided from the first coupler and the second coupling signal provided from the second coupler.

5. The electronic device of claim 1,
wherein the instructions, when executed by the at least one processor, cause the electronic device to change a transmission power outputted through the RF transceiver based on identifying that a difference between an electrical characteristic of the first coupling signal and an electrical characteristic of the second coupling signal exceeds a reference value.

6. The electronic device of claim 5,
wherein the instructions, when executed by the at least one processor, cause the electronic device to:
control the RF transceiver to output a signal with a first transmission power based on identifying that the difference between the electrical characteristic of the first coupling signal and the electrical characteristic of the second coupling signal exceeds the reference value, and
control the RF transceiver to output the signal with a second transmission power lower than the first transmission power while the RF transceiver outputs the signal with the first transmission power based on identifying that the difference between the electrical characteristic of the first coupling signal and the electrical characteristic of the second coupling signal is equal to or less than the reference value.

7. The electronic device of claim 5,
wherein the electrical characteristic comprises at least one of power of the first coupling signal and the second coupling signal, a signal to noise ratio (SNR) of the first coupling signal and the second coupling signal or a voltage standing wave ratio (VSWR) of the first coupling signal and the second coupling signal.

8. The electronic device of claims 1, further comprising an antenna electrically connected to the second coupler through the second substrate, and
wherein the instructions, when executed by the at least one processor, cause the electronic device to change an operating frequency of a signal to be transmitted through the antenna based on identifying that a difference between the electrical characteristic of the first coupling signal and the electrical characteristic of the second coupling signal exceeds a reference value.

9. The electronic device of claim 1, further comprising:
an antenna electrically connected to the second coupler through the second substrate; and
an antenna switching circuit including at least one of an inductor or a capacitor electrically connected to the antenna, and
wherein the instructions, when executed by the at least one processor, cause the electronic device to change an inductance of the inductor or a capacitance of the capacitor, electrically connected to the antenna, based on identifying that a difference between the electrical characteristic of the first coupling signal and the electrical characteristic of the second coupling signal exceeds a reference value.

10. The electronic device of claims 1, further comprising:
an antenna electrically connected to the second coupler through the second substrate; and
another antenna electrically connected the first substrate, and
wherein the instructions, when executed by the at least one processor, cause the electronic device to change an antenna to be used for communication with an external electronic device from the antenna to the other antenna based on identifying that a difference between the electrical characteristic of the first coupling signal and the electrical characteristic of the second coupling signal exceeds a reference value.

11. The electronic device of claim 1,
wherein the instructions, when executed by the at least one processor, cause the electronic device to:
receive a forward coupling signal of the first signal and a reverse coupling signal of the first signal, provided from the first coupler, and a forward coupling signal of the second signal and a reverse coupling signal of the second signal, provided from the second coupler, and
change an impedance of a signal outputted through the RF transceiver based on identifying that a difference between a first voltage standing wave ratio (VSWR), based on the forward coupling signal of the first signal and the reverse coupling signal of the first signal, and a second VSWR, based on the forward coupling signal of the second signal and the reverse coupling signal of the second signal, exceeds a reference value.

12. The electronic device of claim 1,
wherein the third substrate comprises:
a forward coupling signal line configured to transmit a forward coupling signal of the second signal;
a reverse coupling signal line configured to transmit a reverse coupling signal of the second signal; and
at least one signal line disposed between the forward coupling signal line and the reverse coupling signal line.

13. The electronic device of claim 1,
wherein the second substrate is disposed on one surface of the first housing part, and
wherein the second coupler includes a conductive pattern embedded in the second substrate.

14. The electronic device of claim 1, further comprising a switching circuit disposed on the first substrate and configured to electrically connect the first coupler or the second coupler to the RF transceiver, and
wherein the instructions, when executed by the at least one processor, cause the electronic device to:
obtain the first coupling signal based on electrically connecting the at least one processor and the first coupler through the switching circuit, and
obtain the second coupling signal based on electrically connecting the at least one processor and the second coupler through the switching circuit.

15. The electronic device of claim 1, further comprising a display including a first display area and a second display area at least partially bendable into the first housing part based on the movement of the first housing part or the second housing part,
wherein the at least a portion of the second display area is rolled into the first housing part in a first state and drawn from the inside of the first housing part to an outside of the first housing part in a second state.

16. An electronic device comprising:
a memory storing instructions;
a first substrate;
a second substrate spaced apart from the first substrate;
a third substrate electrically connecting the first substrate and the second substrate and including a first connector connected to the first substrate and a second connector connected to the second substrate;
at least one processor disposed on the first substrate;
an RF transceiver disposed on the first substrate;
a first coupler disposed on the first substrate and configured to provide a first coupling signal based on the first signal from the RF transceiver;
a second coupler disposed on the second substrate and configured to provide a second coupling signal based on the second signal from the third substrate; and
an antenna electrically connected to the second coupler through the second substrate,
wherein the instructions, when executed by the at least one processor, cause the electronic device to:
identify a difference between an electrical characteristic of the first coupling signal provided from the first coupler and an electrical characteristic of the second coupling signal provided from the second coupler, and
change a transmission power outputted through the RF transceiver, based on identifying that a difference between the electrical characteristic of the first coupling signal and the electrical characteristic of the second coupling signal exceeds a reference value.

17. The electronic device of claim 16,
wherein the first coupler is disposed between the RF transceiver and the first connector, and
wherein the second coupler is disposed between the second connector and the antenna.

18. The electronic device of claim 16,
wherein the electrical characteristic of the first coupling signal includes at least one of a power of the first coupling signal, a signal to noise ratio (SNR) of the first coupling signal, or a voltage standing wave ratio (VSWR) of the first coupling signal, and
wherein the electrical characteristic of the second coupling signal includes at least one of a power of the second coupling signal, an SNR of the second coupling signal, or a VSWR of the second coupling signal.

19. The electronic device of claim 16,
wherein the instructions, when executed by the at least one processor, cause the electronic device to change an operating frequency of a signal to be transmitted through the antenna, based on identifying that the difference between the electrical characteristic of the first coupling signal and the electrical characteristic of the second coupling signal exceeds the reference value.

20. The electronic device of claim 16, further comprising another antenna electrically connected to the first substrate, and
wherein the instructions, when executed by the at least one processor, cause the electronic device to change an antenna to be used for communication with an external electronic device from the antenna to the other antenna, based on identifying that a difference between the electrical characteristic of the first coupling signal and the electrical characteristic of the second coupling signal exceeds a reference value.
